(19) United States
(12) Patent Application Publication
(10) Pub. No.: US 2026/0196479 A1
(43) Pub. Date: Jul. 9, 2026

(54) LOW-COBALT OR COBALT-FREE CATHODE MATERIALS WITH BIMODAL PARTICLE SIZE DISTRIBUTION FOR LITHIUM BATTERIES

(71) Applicant: TexPower, Inc., Houston, TX (US)

(72) Inventors: Wangda Li, Houston, TX (US); Evan M. Erickson, Houston, TX (US); Ryan Pekarek, Austin, TX (US); Gabriel S.V. Martins, Houston, TX (US); Vivian Kuykendall, Houston, TX (US); Julia Lamb, Haverhill, MA (US)

(21) Appl. No.: 19/124,755

(22) PCT Filed: Oct. 26, 2023
(86) PCT No.: PCT/US2023/036040

§ 371 Date: Apr. 25, 2025

Related U.S. Application Data
(60) Provisional application No. 63/419,520, filed on Oct. 26, 2022.

(51) Int. Cl. H01M 4/36; H01M 4/02; H01M 4/525; H01M 4/58

(52) U.S. Cl. CPC H01M 4/364; H01M 4/525; H01M 4/5825; H01M 2004/021

(57) ABSTRACT

A particulate composition comprises a mixture of a plurality of particles, wherein the mixture comprises a first particle group comprising a first portion of the particles, wherein the particles of the first particle group comprise one or more first electrode active materials and have a first median particle size, and a second particle group comprising a second portion of the particles, wherein the particles of the second particle group comprise one or more second electrode active materials and have a second median particle size, wherein a ratio of the first median particle size to the second median particle size is at least 2.75.

### CROSS-REFERENCE TO RELATED APPLICATIONS

This application is a U.S. National Stage Filing under 35 U.S.C. 371 from International Application No. PCT/US2023/036040, filed on Oct. 26, 2023, and published as WO 2024/091625 on May 2, 2024, which claims the benefit of priority to U.S. Provisional Patent Application Ser. No. 63/419,520, entitled “LOW-COBALT OR COBALT-FREE CATHODE MATERIALS WITH BIMODAL PARTICLE SIZE DISTRIBUTION FOR LITHIUM BATTERIES,” filed on Oct. 26, 2022, the disclosure of which is incorporated by reference herein in its entirety.

### STATEMENT REGARDING FEDERALLY SPONSORED RESEARCH OR DEVELOPMENT

This invention was made with government support under Grant No. DE-SC0020025 awarded by the U.S. Department of Energy. The U.S. government has certain rights in the invention.

### BACKGROUND

The most commonly-used cathode materials for commercially-available high-energy density batteries are made from lithium metal oxides, e.g., having the general formula LiₐM_{b}Oc, wherein M comprises one or more metal or metalloid elements, and a, b, and c are the relative molecular amounts of lithium, the metal or metalloid elements, and oxygen, respectively. In common examples, a=1, b=1, and c=2. Metals that are commonly-used as the metal M, include, but are not limited to, Ni, Co, Mn, Al, Fe, Ti, or V.

Conventionally, the most common cathode materials for rechargeable high energy density Li-ion batteries contain cobalt, such as lithium cobalt oxide, LiCoO₂. The use of cobalt in the cathode material of commercial lithium-ion batteries, however, has had several challenges. First off, cobalt is a scare material that is only found in a few places on earth. Nearly two thirds of global cobalt supply is controlled by the Democratic Republic of the Congo (DRC) in Central sub-Saharan Africa. The DRC has a reputation of being controlled by unstable political regimes, which has led to disruptions in the global cobalt supply chain. In addition, the cobalt mining industry of the DRC has been known for less than ideal environmental practices and poor labor practices, including exploitation of child labor. Because of this reputation and these practices, the price of cobalt can undergo wild price swings. For example, on Jan. 1, 2017, the price of cobalt was about $33,000 per metric ton. A year later, on Jan. 1, 2018, the price had increased by 127% to a then all-time high of about $75,000 per metric ton. Then, in just two months, by late March 2019, the price had increased even further, to $95,000 per metric ton, a 26% increase since the start of the year and a 187% increase since the start of 2017. Then, the price collapsed over the next nine (9) months down to about $55,000 per metric ton on Dec. 30, 2018, only to close out the roller coaster of 2018 with a massive crash in value of 35% on New Year's Eve to end 2018 at about $35,000 per metric ton, or just slightly above where it had begun two years before.

Even without these wild swings in price and without disruptions in the global cobalt supply chain, demand for cobalt is expected to outstrip new production in the coming decade. Major users of cobalt include high energy density batteries, as discussed above, as well as part of alloys for gas turbine blades and jet aircraft engines, special steel grades, carbides, and in magnets. For example, the production of electric cars, which is one of the fasting growing industries that use large amounts of high-energy density batteries, is projected to undergo a ten-fold production increase from 2018 to 2025. Similarly, the markets for other portable electric devices, such as mobile phones, computers, and other personal electronic devices, is expected to grow quickly.

This rapid expansion of mobile or portable electronics and the unstable supply of cobalt has led to a growing consensus to reduce cobalt usage in general, and in particular in lithium-based battery materials. Cobalt-free or low-cobalt materials are commercially available—such as lithium iron phosphate (LiFePO₄) or lithium manganese oxide (e.g., LiMnO₂, LiMn₂O₄, Li₂MnO₂, or Li₂MnO₄)—however, they offer substantially lower energy content compared to batteries with cobalt-containing cathode materials and typically cannot meet the stringent requirements of next-generation electronics batteries for electric vehicles or other portable or mobile electronics. Other emerging cobalt-free cathode technologies such as 5 V spinel oxides, layered lithium-excess oxides, sulfur, and metal fluorides will necessitate a fundamental change of current lithium battery chemistry, which likely will take a decade or more development time.

### SUMMARY

The present disclosure describes a particle size distribution and packing configuration of the material that forms one or more electrodes of a high-energy battery, such as the particles of a cathode material. The particle size distribution and packing configuration of the present disclosure provides for more efficient packing density of the particles compared to existing cathode material particle size distributions and, therefore, can provide higher gravimetric energy density, higher volumetric energy density, higher rate capability, higher first-cycle coulombic efficiency, longer operational lifetime over a wide temperature range (e.g., from subzero to elevated temperatures), and/or better safety features under abuse (e.g., short circuit, overcharge, rupture). The present disclosure also describes a battery electrode, e.g., a cathode, formed from electrode material particles having the particle size distribution and packing configuration described herein. Finally, the present disclosure also describes a high-energy battery wherein at least one electrode, such as the cathode, of the battery is formed from the electrode material having the particle size distribution and particle packing configuration described herein.

This summary is intended to provide an overview of subject matter of the present disclosure. It is not intended to provide an exclusive or exhaustive explanation of the invention. The detailed description is included to provide further information about the present disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is schematic illustration of an example electrochemical cell according to at least some aspects of the present disclosure.

FIG. 2 is a schematic illustration of first and second particle groups each having a specified particle size distribution that can be mixed together to form a particulate composition having a bimodal particle size distribution according to at least some aspects of the present disclosure.

FIG. 3 is a flow diagram of an example process of manufacturing an electrode active material according to at least some aspects of the present disclosure.

FIGS. 4A and 4B are scanning electron microscopy images of the smaller sized particle group and the larger sized particle group of EXAMPLE 1.

FIG. 5 is a graph of the tapped densities of various mixtures of the smaller sized particles and larger sized particles of EXAMPLE 1.

FIGS. 6A-6E are scanning electron microscopy images for the determination of cracked particles as the result of application of a specified applied pressure to the particle groups and the particle mixture of EXAMPLE 1.

FIG. 7 is a graph of specific discharge capacities of various coin cells incorporating the particle mixtures of EXAMPLE 1.

FIG. 8 is a graph showing a comparison of tapped densities for a mixtures formed by blending the particle groups of EXAMPLE 1 versus stirring the particle groups of EXAMPLE 1.

FIG. 9 is a graph showing the effect of blending time of the tapped density of a mixture comprising the particle groups of EXAMPLE 1.

FIGS. 10A and 10B are scanning electron microscopy images of the smaller sized particle group and the larger sized particle group of EXAMPLE 3.

FIGS. 11A-11C are scanning electron microscopy images of the smaller sized particle group, the intermediate sized particle group, and the larger sized particle group of EXAMPLE 4.

### DETAILED DESCRIPTION

The following detailed description describes a particulate composition with a specified particle size distribution that provides for a specified particle packing configuration that collectively forms a portion of the electrode, for example that forms a portion of the positive electrode (i.e., cathode) active material. In an example, the particulate composition forms the electrode of a rechargeable lithium-based battery.

In an example wherein the particulate composition of the present disclosure is used as the cathode active material, the particles of the composition can be a material comprising no more than a specified amount of cobalt, which will be referred to hereinafter as “a low-cobalt material” or “an ultralow-cobalt material,” or more briefly as “low-cobalt” or “ultralow-cobalt.” In some examples, the particles of the cathode active material can be made that entirely exclude or substantially entirely exclude cobalt, which will be referred to hereinafter as “a cobalt-free material,” or more briefly as “cobalt-free.” Those having skill in the art will appreciate that other terms can be used to describe materials belonging to the class of materials of the present disclosure such as, but not limited to, “zero-cobalt,” “cobalt-light,” “cobalt-deficient,” “cobalt-scarce,” “no-cobalt,” or “cobalt-less.” Those having skill in the art will also appreciate that the present disclosure may use the chemical symbol for Cobalt, Co, when describing the amount of cobalt in the cathode active material of the particulate composition—e.g., “low-Co” or “Co-free”—without varying from the scope of the present disclosure. However, the present disclosure will primarily describe the active materials that can be formed into a cathode as “low-cobalt or cobalt-free cathode material” or simply as “low-Co or Co-free material.” The low-cobalt or cobalt-free material can be made from raw materials of a relatively higher earth abundance than cobalt and, as such, can be obtained at a lower cost, via more secure supply chains, and with less adverse environmental impact than cobalt.

The electrode active materials and the particulate compositions made therefrom can be easily tuned in chemical composition and particle size distribution to provide higher gravimetric energy density, higher volumetric energy density, higher rate capability, higher first-cycle coulombic efficiency, longer operational lifetime over a wide temperature range (e.g., from subzero to elevated temperatures), and/or better safety features under abuse (e.g., short circuit, overcharge, rupture). The electrode active materials described herein can be readily compatible with existing components in commercial lithium-ion batteries, such as graphite/silicon anodes, polymeric separators, and non-aqueous aprotic carbonate-based electrolytes.

Cathodes made from the particulate active material compositions described herein have been evaluated and validated in pouch format full cells. The electrode active materials can be synthesized via established industrial manufacturing processes, such as metal co-precipitation, lithiation calcination, and can be treated with optional subsequent surface treatments. A series of metals and/or non-metals can be incorporated into the active material of the particulate compositions to enable desirable gravimetric energy density, volumetric energy density, rate capability, operational lifetime, and safety in the absence of cobalt or in very low concentrations of cobalt. The described cathode active material particulate compositions demonstrate promise for future low-cobalt or cobalt-free, high-energy-density lithium-based batteries, including both lithium-ion and lithium-metal chemistries in either liquid, semi-solid, or all-solid-state electrolyte systems.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range. The statement “about X to Y” has the same meaning as “about X to about Y,”” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Electrochemical Cell

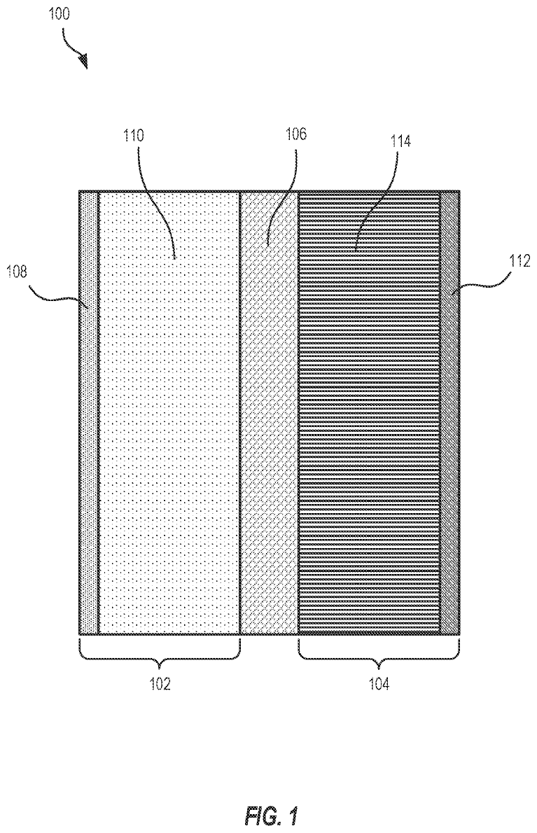

The particulate compositions of the electrode active materials described herein can be useful in electrochemical cells and batteries. FIG. 1 is a schematic illustration of an example electrochemical cell 100 that can incorporate the particulate composition electrode active materials described herein. As shown in FIG. 1, in an example, the electrochemical cell 100 comprises a cathode 102 and an anode 104 with a separator 106 interposed between the cathode 102 and the anode 104.

The cathode 102 can be formed from a cathode current collector 108 that is at least partially coated with a cathode active material 110. The cathode current collector 108 can be any suitable current collector, such as those that are known and used in the art of high-energy lithium batteries. In an example, the cathode current collector 108 comprises aluminum, such as an aluminum foil. The cathode active material 110 can comprise any of the electrode active materials described herein, such as the particulate compositions formed from particles of the active material having the general chemical formula [1] described below. In an example, the particulate composition of the cathode active material 110 can have the specified particle size distribution described herein. In an example, the cathode active material 110 is mixed with one or more additives, such as one or more binding agents, one or more conductive additives, one or more liquid electrolytes, and/or one or more solid electrolytes, as is known in the art. In an example, the coating on the current collector 108 can have an active mass loading of from about 2 milligrams per square centimeter (mg/cm²) to about 30 mg/cm².

The anode 104 can be formed from an anode current collector 112 that is at least partially coated with an anode active material 114. The anode current collector 112 can be any suitable current collector, such as those that are known and used in the art of high-energy lithium batteries. In an example, the anode current collector 112 comprises copper, such as a copper foil. In some examples, the anode current collector 112 can be omitted from the electrochemical cell 100. The cathode active material 110 can comprise any anode active material that is known or later discovered for use as the anode in high-energy lithium batteries. Examples of materials that can be used to form the anode active material 114 include, but are not limited to, carbon (C) in forms such as graphite or hard carbon, silicon (Si), lithium titanate (Li₅Ti₅O₁₂), tin (Sn), antimony (Sb), zinc (Zn), phosphorous (P), lithium metal (Li), or combinations thereof. In some examples, one or more of the active material that forms the anode active material 114 can be a particulate material, such as a particulate composition having the specified particle size distribution described herein. In an example, the anode active material 114 is mixed with one or more additives, such as one or more binding agents, one or more conductive additives, one or more liquid electrolytes, and/or one or more solid electrolytes, as is known in the art.

In an example, an active material coating comprising a particulate active material can be formed by coating an electrode body (such as the cathode current collector 108 and/or the anode current collector 112) with a coating composition comprising the particulate active material (such as the mixtures of electrode active materials described herein), a binding agent, one or more optional conductive additives, and a solvent. After the coating composition is coated onto the electrode body, the solvent can be evaporated, which leaves an electrode coating that comprises the particulate active material, the binding agent, and the one or more optional conductive additives. An example of a solvent that can be used to form the coating composition for this method is methyl-2-pyrrolidone, although the method is not limited to only this solvent. In an example, the solvent is less than about 90 wt. % of the coating composition that is coated onto the electrode body.

Examples of binding agents that can be used for the cathode or the anode active materials include, but are not limited to, at least one of: polyvinylidene difluoride (PVDF), carboxy methyl cellulose (CMC), styrene-butadiene rubber (SBR), and polyacrylic acid. Examples of conductive additives that can be included in the cathode or the anode active materials include, but are not limited to, at least one of: carbon black and carbon nanotubes.

The separator 106 is interposed between the anode 104 and the cathode 102 and can provide a pathway for ions, such as the Li+ ions in a lithium-based battery. The separator 106 can be made from any suitable non-reactive material that is known in the art. In an example, the pathway or pathways provided by the separator 106 have a low resistance with respect to the ion migration of one or more electrolyte materials that are included in the electrochemical cell 100, while still providing for good moisture retention of the non-aqueous solvent of the electrolyte solution (in the case of liquid electrolytes). In an example, the separator 106 is a porous film, sheet, or mat, wherein the ion pathways can be formed through the pores of the porous structure. In an example, the pores may have an appropriate size so that they can be filled with an electrolyte material. In some examples, the material of the separator 106 can itself function as an electrolyte. The electrolyte material of the separator 106, e.g., an electrolyte within the pores of the separator 106 or where the material of the separator 106 itself is an electrolyte, or both, conducts ions back and forth between the cathode active material 110 and the anode active material 114.

Example materials that can be used to form the separator 106 include, but are not limited to, olefin-based polymers (such as a polypropylene or polyethylene homopolymer or an ethylene/butylene or ethylene/hexene copolymer), acrylic polymers (such as poly(methyl methacrylate) or polyacrylonitrile), an acrylic copolymer (such as an ethylene/methacrylate copolymer), or a woven or non-woven mat made from a high melting point fiber, such as glass fibers or polyethylene terephthalate (PET) fibers. Example electrolytes can be a liquid electrolyte with salts dissolved in an organic solvent, e.g., a non-aqueous and/or aprotic polar solvent (such as one or more of dimethyl carbonate, diethyl carbonate, or ethyl methyl carbonate), or one or more solid electrolytes such as one or more solid ceramic electrolytes or a solid cyclic carbonate electrolyte. Solid, ethylene carbonate can be added to the solvent(s) to help passivate the anode surface during cycling of the battery. The electrolyte material can include one or more lithium salts dissolved in the organic solvent, such as lithium hexafluorophosphate (LiPF₆), lithium tetrafluoroborate, (LiBF₄), or lithium perchlorate (LiClO₄), or it can include one or more lithium compounds incorporated into a solid electrolyte, such as a lithium metal oxide incorporated into a ceramic or glassy solid structure.

### Cathode Active Material Particulate Composition

As mentioned above, in an example, one or more of the electrode active materials described herein, such as the anode active material 114 of the electrochemical cell anode 104 or the cathode active material 110 of the electrochemical cell cathode 102, can be formed from a composition comprising a plurality of particles, e.g., as a particulate powder, of a specified electrode active material, which will also be referred to hereinafter as “the electrode active material particulate composition” or simply “the particulate composition.” For example, the cathode 102 of the electrochemical cell 100 can be formed by coating the cathode current collector 108 with a particulate composition of a specified cathode active material 110 (e.g., from a lithium-based layered oxide active material such as one having the chemical formula LiₐNi_{(1-b-c)}Co_{b}M_{c}O_{d} as described in more detail below). In an example, the cathode active material particulate composition can be coated onto the cathode current collector 108 via known slurry-based deposition or particulate assembly methods. In an example, the cathode active material particles can be bound together and to the cathode current collector 108 with one or more binders, as well as being interspersed with one or more conductive additives, one or more liquid electrolytes, and/or one or more solid electrolytes, as described above.

The electrode active material particulate composition of the present disclosure has a combination of particles sizes that the present inventors have found to be particularly beneficial for denser packing of the particles and other performance characteristics that make up the particulate composition. The term “particle size,” as used herein, refers to a measurement of the maximum dimension of a particle, such as the diameter of a spherical or disc-shaped particle, the length of a rod-shaped particle, the diagonal of a cube shaped particle, the bisector of a triangular shaped particle, and so on. In most commercial particulate electrode active material manufacturing processes, the particles that are formed generally have a spherical or substantially spherical or ovular shape. In an example, the particles of active material that make up the particulate composition are spherical or substantially spherical in shape, which have a “size” defined by their particle diameter. Therefore, in some examples herein, a shorthand for “particle size” that can be used is “D.”

In an example, the particle size of the particles that make up the particulate composition ranges from about 500 nanometers (nm) to about 30 micrometers (μm), such as from about 1 μm to about 20 μm, for example from about 2.5 μm to about 15 μm, such as from about 5 μm to about 12.5 μm, for example from about 7.5 μm to about 10 μm. Example values for the particle size of specified portions of the particulate composition population (e.g., the diameter of spherical or substantially spherical particles) includes: about 500 nm, about 550 nm, about 600 nm, about 650 nm, about 700 nm, about 750 nm, about 800 nm, about 850 nm, about 900 nm, about 950 nm, about 1 μm, about 1.05 μm, about 1.1 μm, about 1.15 μm, about 1.2 μm, about 1.25 μm, about 1.3 μm, about 1.35 μm, about 1.4 μm, about 1.45 μm, about 1.5 μm, about 1.55 μm, about 1.6 μm, about 1.65 μm, about 1.7 μm, about 1.75 μm, about 1.8 μm, about 1.85 μm, about 1.9 μm, about 1.95 μm, about 2 μm, about 2.1 μm, about 2.2 μm, about 2.3 μm, about 2.4 μm, about 2.5 μm, about 2.6 μm, about 2.7 μm, about 2.8 μm, about 2.9 μm, about 3 μm, about 3.1 μm, about 3.2 μm, about 3.3 μm, about 3.4 μm, about 3.5 μm, about 3.6 μm, about 3.7 μm, about 3.8 μm, about 3.9 μm, about 4 μm, about 4.1 μm, about 4.2 μm, about 4.3 μm, about 4.4 μm, about 4.5 μm, about 4.6 μm, about 4.7 μm, about 4.8 μm, about 4.9 μm, about 5 μm, about 5.1 μm, about 5.2 μm, about 5.3 μm, about 5.4 μm, about 5.5 μm, about 5.6 μm, about 5.7 μm, about 5.8 μm, about 5.9 μm, about 6 μm, about 6.1 μm, about 6.2 μm, about 6.3 μm, about 6.4 μm, about 6.5 μm, about 6.6 μm, about 6.7 μm, about 6.8 μm, about 6.9 μm, about 7 μm, about 7.1 μm, about 7.2 μm, about 7.3 μm, about 7.4 μm, about 7.5 μm, about 7.6 μm, about 7.7 μm, about 7.8 μm, about 7.9 μm, about 8 μm, about 8.1 μm, about 8.2 μm, about 8.3 μm, about 8.4 μm, about 8.5 μm, about 8.6 μm, about 8.7 μm, about 8.8 μm, about 8.9 μm, about 9 μm, about 9.1 μm, about 9.2 μm, about 9.3 μm, about 9.4 μm, about 9.5 μm, about 9.6 μm, about 9.7 μm, about 9.8 μm, about 9.9 μm, about 10 μm, about 10.2 μm, about 10.4 μm, about 10.6 μm, about 10.8 μm, about 10.9 μm, about 11 μm, about 11.2 μm, about 11.4 μm, about 11.6 μm, about 11.8 μm, about 12 μm, about 12.2 μm, about 12.4 μm, about 12.6 μm, about 12.8 μm, about 13 μm, about 13.2 μm, about 13.4 μm, about 13.6 μm, about 13.8 μm, about 14 μm, about 14.2 μm, about 14.4 μm, about 14.6 μm, about 14.8 μm, about 15 μm, about 15.2 μm, about 15.4 μm, about 15.6 μm, about 15.8 μm, about 16 μm, about 16.2 μm, about 16.4 μm, about 16.6 μm, about 16.8 μm, about 17 μm, about 17.2 μm, about 17.4 μm, about 17.6 μm, about 17.8 μm, about 18 μm, about 18.2 μm, about 18.4 μm, about 18.6 μm, about 18.8 μm, about 19 μm, about 19.2 μm, about 19.4 μm, about 19.6 μm, about 19.8 μm, about 20 μm, about 20.5 μm, about 21 μm, about 21.5 μm, about 22 μm, about 22.5 μm, about 23 μm, about 23.5 μm, about 24 μm, about 24.5 μm, about 25 μm, about 25.5 μm, about 26 μm, about 26.5 μm, about 27 μm, about 27.5 μm, about 28 μm, about 28.5 μm, about 29 μm, about 29.5 μm, or 30 μm, or a range with any two of these values as the endpoints.

The particles that make up the particulate composition can be described as “secondary particles.” In an example, each “secondary particle” can be formed from a plurality of separate particles, referred to as “primary particles,” that are aggregated together to form the secondary particle. In an example, the primary particles can be uniform or substantially uniform particles (e.g., having substantially uniform sizes and/or with regular geometric shapes) or non-uniform. In an example, each primary particle can be single crystal structures formed from the same or substantially the same material. In an example, the primary particles are rod shaped and aligned radially from the interior to the exterior of a secondary particle. In an example, the references to “particle size” and “particle size distribution” for the particulate composition are referring to the sizes of the secondary particles that form the particulate composition and not necessarily the size of the individual primary particles that make up the secondary particles.

In an example, each secondary particle can comprise from 1 to about 100,000,000 or more primary particles. In an example, the secondary particles can have a cross-sectional particle size of from about 500 nm to about 30 μm, while the primary particles that make up the secondary particles can have a cross-sectional dimension of from about 10 nm to about 10 μm, such as from about 10 nm to about 100 nm, from about 100 nm to about 1000 nm (which is 1 μm), or from about 1 μm to about 10 μm. In an example, the primary particles that when agglomerated form the secondary particles can be monodisperse or substantially monodisperse (e.g., with each of the primary particles having the same or substantially the same cross-sectional size). In some examples, one or more of the secondary particles can comprise a single primary particle, which is also referred to as a “single-crystalline particle,” a “single-crystal particle,” or a “single crystal.”

In an example, at least one of the particle groups that forms the particulate composition comprises secondary particles comprising a spherical morphology. In such an example, each of the secondary particles comprise a plurality of smaller primary particles (as described above). In an example of the spherical morphology secondary particles, a diameter size ratio of the primary particles relative to the secondary particles (e.g., as calculated with SEM-measured areas) is from about 0.0005 to about 1.

### Particle Size Distribution of Particulate Composition

As mentioned above, the active material particulate composition described herein, such as cathode material particulate composition formed from particles of a lithium-based layered oxide active material having the chemical formula LiₐNi_{(1-b-c)}Co_{b}M_{c}O_{d}, have a particle size distribution that is specifically controlled for better particle packing such that an electrode formed from the electrode active material particulate composition can have a higher packing density, and therefore a higher volumetric energy density, as well as some other advantageous attributes, than other particulate compositions having a more conventional particle size distribution.

The phrase “particle size distribution,” as used herein, refers to a method of characterizing particle sizes across the population of the particulate composition. In an example, the phrase “particle size distribution” can refer to an expression of the relative amount of particles in the overall population of the particulate composition that are at each particle size within the total size range of the population. More specifically, the phrase “particle size distribution” (or “the size distribution” or “the distribution”) can refer to an index of specified particle size ranges (e.g., from about 100 nanometers (nm) to about 500 nm, or from about 1 micrometer (μm) to about 10 μm) and a measure of the amount of particles from the particulate composition population that fall within each specified size range. In an example, the measure of the amount of particles in any particular range can be a proportion or percentage of the population, such as “X % of the particles fall within the range of from Y micrometers to Z micrometers.” In another example, the measure of the amount of particles can be the weight percentage of the particles that fall within that range (e.g., the weight of the particles that fall within the range divided by the total weight of all of the particles in the population). In still another example, the measure of the amount of particles can be an absolute measure, such as the weight of the particles that fall within a particular size range.

In some examples, the specified size ranges are uniform in terms of the spread of the range (e.g., the difference between the largest size value for a particular size range and the smallest size value for the same size range), such that the spread of each specified size range is the same or substantially the same (with the possible exception of the smallest size range, which can cover any and all particles below a specified particle size down to an expected minimum size that could be arbitrarily defined as being down to a size of zero, and the largest size range, which can cover an and all particles larger than a specified maximum particle size). For example, if all or substantially all of the particles in the particulate composition population have a particle size D of from about 100 nm (or about 0.1 μm) and about 10 μm, then the particle size distribution can comprise: (1) a first size range for 0<D≤1 μm; (2) a second size range for 1 μm<D≤2 μm; (3) a third size range for 2 μm<D≤3 μm; (4) a fourth size range for 3 μm<D≤4 μm; (5) a fifth size range for 4 μm<D≤5 μm; (6) a sixth size range for 5 μm<D≤6 μm; (7) a seventh size range for 6 μm<D≤7 μm; (8) an eighth size range for 7 μm<D≤8 μm; (9) a ninth size range for 8 μm<D≤9 μm; and (10) a tenth size range for 9 μm<D≤10 μm. As can be seen, each of the ten specified size ranges have a spread of 1 μm. As can also be seen, in this example of a size distribution, the specified size ranges that are used to characterize the particle size distribution are contiguous and collectively cover all of the particle sizes for the entire population of particles. Specifically, the definition of the size ranges (i.e., the upper and lower endpoints and whether values within the range must be greater than, greater than or equal to, less then, or less than or equal to the endpoints of the range) are such that each and every potential numerical value from 0 to 10 μm can only be part of one, and only one, of the 10 specified size ranges.

In another example, one or more of the specified size ranges for the particle size distribution for the active material particulate composition of the present disclosure can be defined with reference to a median particle size of all or a portion of the particles within the specified size range. As used herein, the phrase “median particle size” refers to the statistical median particle size of the particles in a specified portion of the population of the particulate composition. In an example where a specified size range is defined by a median particle size, the specified size range can be defined by a particular median particle size and a specified deviation from the particular median particle size. For example, one size range for the particle size distribution of the particulate composition of the present invention can be defined as any size value that is within a specified absolute length of a specified median particle size (e.g., defining the specified size range as any particle with a size within 250 nm of the specified median particle size of 1 μm, or from about 0.75 μm to about 1.25 μm). In another example, the specified size range as a relative amount of another value, such as defining a specified size range as any particle size that is within a specified percentage of a specified median particle size of the specified median particle size itself (e.g., defining a specified size range as including any particle with a size that is within 15% of the specified median particle size of 3 μm, or from about 2.55 μm (85% of the 3 μm median particle size) to about 3.45 μm (115% of the 3 μm median particle size).

### Multimodal Particle Size Distribution

Particulate electrode active materials that are lithium-based layered oxides and are manufactured according to most standardized processes in the battery industry, and in particular to standardized processes in the electrode active material particulate material manufacturing industry typically result in spherically or substantially spherical particles with a relatively wide total size range wherein the particle diameters are diffusely distributed throughout the wide size range. For example, a first batch of particles of a first electrode active material that is made by such standardized processes can have particle diameters ranging from about 1 μm to about 20 μm with an average particle diameter of about 8 μm and wherein the diameters of the first batch particles are relatively evenly distributed throughout the entire size range.

However, process controls can be put into place that can provide for narrower size distribution ranges and with a higher proportion of the particles falling within the target size range. For example, process controls can be implemented for the same general process that made the first batch of particles in order to manufacture a second batch of particles of the same first electrode active material. The process controls can allow the size distribution of the second batch of particles to be much narrower than that of the first batch, e.g., with an overall size range of from about 6 μm to about 10 μm with an average particle diameter of about 8 μm, and wherein at least 60-80% of the particles in the second particulate composition are within about 10% of the average particle diameter (e.g., within about 800 nm or about 0.8 μm of 8 μm, or from about 7.2 μm to about 8.8 μm).

The tighter processing controls can be used to make two or more different particulate batches that each have a unique specified median particle size, specified size range, and specified amount of particles within the size range. The two or more particulate batches can then be mixed together to form an overall particulate composition with a desired overall particle size distribution. In a particular example, the two or more particulate batches can be manufactured so that at least two of the particulate batches have significantly different median particle sizes such that when the two or more particulate batches are mixed together, the resulting overall particle size distribution will have two or more relative peaks in the particle size distribution, one peak for each particulate batch with a significantly different median particle size. In statistics, these peaks in a probability or size distribution are referred to as “local maxima” or, more commonly, as “modes.”

The resulting overall particle size distribution with two or more modes can also be referred to generally as a “multimodal” particle size distribution. In an example where the overall particle size distribution has two distinct mode peaks, it can be referred to as a “bimodal” particle size distribution. Similarly, in an example where the overall particle size distribution has three distinct mode peaks, it can be referred to as a “trimodal” particle size distribution. A multimodal particle size distribution is a specific example of a “polydisperse” size distribution, e.g., a size distribution that is non-homogenous and/or that is not “monodisperse.” The term “monodisperse,” as used herein, can refer to a particle size distribution where a substantial portion of the particles in the entire population of the particulate composition (e.g., at least 60% or more of the particles, for example at least 80% or more, at least 85% or more, at least 90% or more, or at least 95% or more of the particles) are within a specified amount of the median particle size for the population (e.g., within 25% of the median particle size, such as within 20%, within 15%, within 10%, or within 5% or less of the median particle size).

The remainder of the present disclosure will describe the particulate composition primarily in the context of a bimodal particle size distribution with some additional description of a trimodal particle size distribution. However, those having skill in the art will appreciate that similar concepts can be used to provide a particle size distribution having four (4) or more distinct mode peaks. Therefore, these higher order multimodal particle size distributions are still within the scope of the present disclosure.

### Enhanced Packing From Multimodal Particle Size Distribution

As mentioned above, the overall particle size distribution of the particulate composition of the present disclosure is selected to provide for improved packing density and other advantageous attributes compared to more uniformly dispersed particle size distributions such as monodisperse particulate compositions. The improved packing density and other advantageous attributes can provide for higher gravimetric energy density, higher volumetric energy density, higher rate capability, higher first-cycle coulombic efficiency, longer operational lifetime over a wide temperature range (e.g., from subzero to elevated temperatures), and/or better safety under abuse (e.g., short circuit, overcharge, rupture) compared to the uniformly and/or monodisperse particle size distribution.

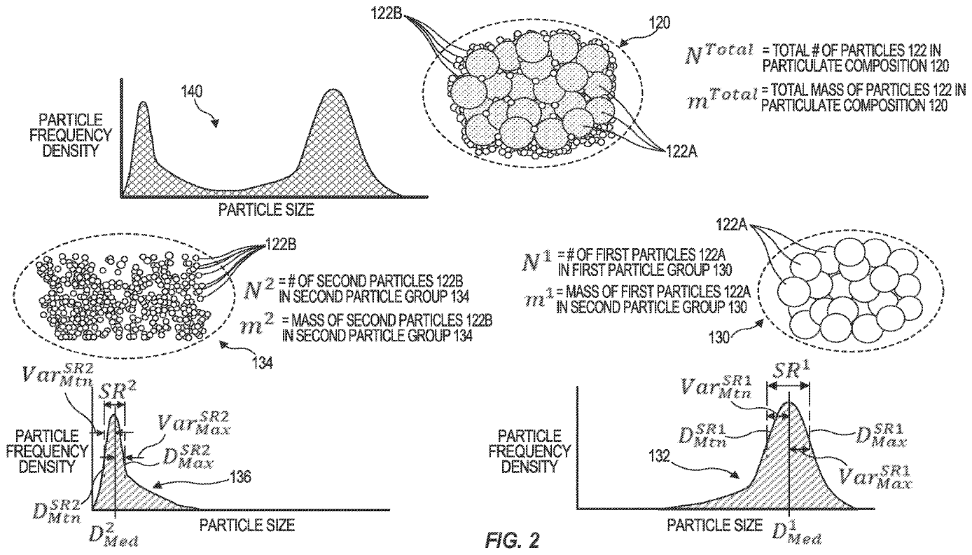

FIG. 2 shows a conceptual representation of a particulate composition 120 that provides for enhanced packing. In an example, the particulate composition 120 comprising a mixture of a plurality of particles 122A, and 122B (collectively “particles 122”) each comprising one or more electrode active materials. In some examples, a certain portion of the particles 122 will be referred to collectively as a “population.” The entirety of the particles 122 that make up the entire particulate composition 120 can also be referred to as the “total population,” such that in some portions of the following description, all of the particles 122 of the particulate composition 120 may be referred to as “the total population 120.” In an example, the total population of the particulate composition 120 has a total number N_{Total} of the particles 122 and has a total mass m_{Total} of the particles 122.

In an example, a substantial percentage of the particles 122 in the particulate composition 120 are made from the same material, for example at least about 80% of N_{Total} or more, such as 90% of N_{Total} or more, for example 95% of N_{Total} or more, or in another example all or substantially all of the total population 120 can be made from the same active material. In an example, a substantial percentage of the particles 122, for example at least about 80% of N_{Total} or more, such as 90% of N_{Total} or more, for example 95% of N_{Total} or more, or in another example all or substantially all of the particles 122 in the total population 120, comprise a lithium-based layered oxide active material, such as the cathode active material having chemical formula [1] (LiₐNi_{(1-b-c)}Co_{b}M_{c}O_{d}), as described in more detail below.

In an example, the total population 120 of the particles 122 has a specified overall particle size distribution that is a bimodal size distribution formed by mixing two groups or batches of the particles. i.e., a first particle group 130 having a first particle size distribution (represented by the distribution graph 132 shown in FIG. 2) and a second particle group 134 having a second particle size distribution (represented by the distribution graph 136 in FIG. 2). When the two particle groups 130, 134 are mixed together, the resulting mixture forms the final particulate composition 120, which will have a specified bimodal size distribution (represented by the distribution graph 140 shown in FIG. 2.

The first particle group 130 comprises a first set of the particles 122A (that is, a subset of the total population 120 of the particles 122) (hereinafter referred to as “the first particles 122A”). In an example, the number of the first particles 122A in the first particle group 130 is N¹ and the mass of the first particles 122A of the first particle group 130 is m¹. The second particle group 134 comprises a second portion 122B of the total population 120 of the particles 122 (hereinafter referred to as “the second particles 122B”). In an example, the number of the second particles 122B in the second particle group 134 is N² and the mass of the second particles 122B of the second particle group 134 is m². In an example, the second particles 122B that form the second particle group 134 are different from the first particles 122A that form the first particle group 130 (e.g., there is little or no overlap between the first particles 122A that make up the first particle group 130 and the second particles 122B that make up the second particle group 134).

As a whole, the first particle group 130 has a first median particle size D¹_{Med} and the second particle group 134 has a second median particle size D²_{Med} that is different from the first median particle size D¹_{Med}, e.g., wherein the second median particle size D²_{Med} is significantly smaller or significantly larger than the first median particle size D¹_{Med}. In an example, the first particles 122A of the first particle group 130 are generally larger than the second particles 122B of the second particle group 134, such as when D¹_{Med}>D²_{Med}, and in some examples when D¹_{Med}>>D²_{Med}, such that the first particle group 130 may also be referred to as the “large particle group 130,” the first particles 122A may also be referred to as the “large particles 122A,” and the first median particle size D¹_{Med} may be referred to as the “large median particle size D^{L}g_{Med}.” Similarly, in such an example, the second particle group 134 may also be referred to as the “small particle group 134,” the second particles 122B may also be referred to as the “large particles 122B,” and the second median particle size D²_{Med} may also be referred to as the “small median particle size D^{Sm}_{Med}.”

The relative sizes of the particles 122A of the first particle group 130 relative to the particles 122B of the second group 134 can be described as a ratio of the first median particle size D¹_{Med} relative to the second median particle size D²_{Med}. This ratio will also be referred to as the “median size ratio R^{1,2}_{Med},” which is defined as R^{1,2}_{Med}=D¹_{Med}/D²_{Med}. In an example, the median size ratio R^{1,2}_{Med} is greater than or equal to a specified size ratio R_{Spec} (i.e., R^{1,2}_{Med}≥R_{Spec}). In an example, the specified ratio R_{Spec} is at least 1.5:1 (i.e., R^{1,2}_{Med}=D¹_{Med}/D²_{Med}≥1.5), such as at least 1.6:1 (i.e., D¹_{Med}/D²_{Med}≥1.6), as at least 1.7:1 (i.e., D¹_{Med}/D²_{Med}≥1.7), at least 1.8:1 (i.e., D¹_{Med}/D²_{Med}≥1.8), at least 1.9:1 (i.e., D¹_{Med}/D²_{Med}≥1.9), at least 2:1 (i.e., D¹_{Med}/D²_{Med}≥2), at least 2.1:1 (D¹_{Med}/D²_{Med}≥2.1), at least 2.2:1 (D¹_{Med}/D²_{Med}≥2.2), at least 2.3:1 (D¹_{Med}/D²_{Med}≥2.3), at least 2.4:1 (D¹_{Med}/D²_{Med}≥2.4), at least 2.5:1 (D¹_{Med}/D²_{Med}≥2.5), at least 2.6:1 (D¹_{Med}/D²_{Med}≥2.6), at least 2.7:1 (D¹_{Med}/D²_{Med}≥2.7), at least 2.8:1 (D¹_{Med}/D²_{Med}≥2.8), at least 2.9:1 (D¹_{Med}/D²_{Med}≥2.9), at least 3:1 (D¹_{Med}/D²_{Med}≥3), at least 3.1:1 (D¹_{Med}/D²_{Med}≥3.1), at least 3.2:1 (D¹_{Med}/D²_{Med}≥3.2), at least 3.3:1 (D¹_{Med}/D²_{Med}≥3.3), at least 3.4:1 (D¹_{Med}/D²_{Med}≥3.4), at least 3.5:1 (D¹_{Med}/D²_{Med}≥3.5), at least 3.6:1 (D¹_{Med}/D²_{Med}≥3.6), at least 3.7:1 (D¹_{Med}/D²_{Med}≥3.7), at least 3.8:1 (D¹_{Med}/D²_{Med}≥3.8), at least 3.9:1 (D¹_{Med}/D²_{Med}≥3.9), at least 4:1 (D¹_{Med}/D²_{Med}≥4), at least 4.1:1 (D¹_{Med}/D²_{Med}≥4.1), at least 4.2:1 (D¹_{Med}/D²_{Med}≥4.2), at least 4.3:1 (D¹_{Med}/D²_{Med}≥4.3), at least 4.4:1 (D¹_{Med}/D²_{Med}≥4.4), at least 4.5:1 (D¹_{Med}/D²_{Med}≥4.5), at least 4.6:1 (D¹_{Med}/D²_{Med}≥4.6), at least 4.7:1 (D¹_{Med}/D²_{Med}≥4.7), at least 4.8:1 (D¹_{Med}/D²_{Med}≥4.8), at least 4.9:1 (D¹_{Med}/D²_{Med}≥4.9), at least 5:1 (D¹_{Med}/D²_{Med}≥5), at least 5.1:1 (D¹_{Med}/D²_{Med}≥5.1), at least 5.2:1 (D¹_{Med}/D²_{Med}≥5.2), at least 5.3:1 (D¹_{Med}/D²_{Med}≥5.3), at least 5.4:1 (D¹_{Med}/D²_{Med}≥5.4), at least 5.5:1 (D¹_{Med}/D²_{Med}≥5.5), at least 5.6:1 (D¹_{Med}/D²_{Med}≥5.6), at least 5.7:1 (D¹_{Med}/D²_{Med}≥5.7), at least 5.8:1 (D¹_{Med}/D²_{Med}≥5.8), at least 5.9:1 (D¹_{Med}/D²_{Med}≥5.9), at least 6:1 (D¹_{Med}/D²_{Med}≥6), at least 6.1:1 (D¹_{Med}/D²_{Med}≥6.1), at least 6.2:1 (D¹_{Med}/D²_{Med}≥6.2), at least 6.3:1 (D¹_{Med}/D²_{Med}≥6.3), at least 6.4:1 (D¹_{Med}/D²_{Med}≥6.4), at least 6.5:1 (D¹_{Med}/D²_{Med}≥6.5), at least 6.6:1 (D¹_{Med}/D²_{Med}≥6.6), at least 6.7:1 (D¹_{Med}/D²_{Med}≥6.7), at least 6.8:1 (D¹_{Med}/D²_{Med}≥6.8), at least 6.9:1 (D¹_{Med}/D²_{Med}≥6.9), at least 7:1 (D¹_{Med}/D²_{Med}≥7), at least 7.1:1 (D¹_{Med}/D²_{Med}≥7.1), at least 7.2:1 (D¹_{Med}/D²_{Med}≥7.2), at least 7.3:1 (D¹_{Med}/D²_{Med}≥7.3), at least 7.4:1 (D¹_{Med}/D²_{Med}≥7.4), at least 7.5:1 (D¹_{Med}/D²_{Med}≥7.5), at least 7.6:1 (D¹_{Med}/D²_{Med}≥7.6), at least 7.7:1 (D¹_{Med}/D²_{Med}≥7.7), at least 7.8:1 (D¹_{Med}/D²_{Med}≥7.8), at least 7.9:1 (D¹_{Med}/D²_{Med}≥7.9), at least 8:1 (D¹_{Med}/D²_{Med}≥8), at least 8.1:1 (D¹_{Med}/D²_{Med}≥8.1), at least 8.2:1 (D¹_{Med}/D²_{Med}≥8.2), at least 8.3:1 (D¹_{Med}/D²_{Med}≥8.3), at least 8.4:1 (D¹_{Med}/D²_{Med}≥8.4), at least 8.5:1 (D¹_{Med}/D²_{Med}≥8.5), at least 8.6:1 (D Med/D²_{Med}≥8.6), at least 8.7:1 (D¹_{Med}/D²_{Med}≥8.7), at least 8.8:1 (D¹_{Med}/D²_{Med}≥8.8), at least 8.9:1 (D¹_{Med}/D²_{Med}≥8.9), at least 9:1 (D¹_{Med}/D²_{Med}≥9), at least 9.1:1 (D¹_{Med}/D²_{Med}≥9.1), at least 9.2:1 (D¹_{Med}/D²_{Med}≥9.2), at least 9.3:1 (D Med/D²_{Med}≥9.3), at least 9.4:1 (D¹_{Med}/D²_{Med}≥9.4), at least 9.5:1 (D¹_{Med}/D²_{Med}≥9.5), at least 9.6:1 (D¹_{Med}/D²_{Med}≥9.6), at least 9.7:1 (D¹_{Med}/D²_{Med}≥9.7), at least 9.8:1 (D) Med/D²_{Med}≥9.8), at least 9.9:1 (D¹_{Med}/D²_{Med}≥9.9), at least 10:1 (D¹_{Med}/D²_{Med}≥10), at least 11:1 (D¹_{Med}/D²_{Med}≥11), at least 12:1 (D¹_{Med}/D²_{Med}≥12), at least 13:1 (D¹_{Med}/D²_{Med}≥13), at least 14:1 (D¹_{Med}/D²_{Med}≥14), at least 15:1 (D¹_{Med}/D²_{Med}≥15), at least 16:1 (D¹_{Med}/D²_{Med}≥16), at least 17:1 (D¹_{Med}/D²_{Med}≥17), at least 18:1 (D¹_{Med}/D²_{Med}≥18), at least 19:1 (D¹_{Med}/D²_{Med}≥19), at least 20:1 (D¹_{Med}/D²_{Med}≥20), at least 21:1 (D¹_{Med}/D²_{Med}≥21), at least 22:1 (D¹_{Med}/D²_{Med}≥22), at least 23:1 (D¹_{Med}/D²_{Med}≥23), at least 24:1 (D¹_{Med}/D²_{Med}≥24), at least 25:1 (D¹_{Med}/D²_{Med}≥25), at least 26:1 (D¹_{Med}/D²_{Med}≥26), at least 27:1 (D¹_{Med}/D²_{Med}≥, 27), at least 28:1 (D¹_{Med}/D²_{Med}≥28), at least 29:1 (D¹_{Med}/D²_{Med}≥29), or at least 30:1 (D¹_{Med}/D²_{Med}≥30).

In an example, at least a first specified portion of the first particle group 130 has a particle size D¹ that is within a first specified particle size range SR¹ (which may also be referred to as the “first particle size range SR¹” or simply the “first size range SR¹”). In an example, the first specified portion of the first particle group 130 that is within the first size range SR¹ is defined as a number percentage, e.g., expressed as X % of the total number N¹ of the first particles 122A in the first particle group 130 that are within the first size range SR¹.

In an example, a number percentage value for the first specified portion of the first particle group 130 having a particle size D¹ within the first specified size range SR¹ is at least 50% of the total number N¹ of the first particles 122A, for example at least 55%, at least 60%, at least 65%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.9%, or at least 99.99% of the total number N¹ of the first particles 122A in the first particle group 130.

In another example, the first specified portion of the first particle group 130 that is within the first size range SR¹ is defined as a weight percentage, e.g., expressed as X wt. % of the total mass m¹ of the first particles 122A in the first particle group 130. In an example, a weight percentage value for the first specified portion of the first particle group 130 having a particle size D¹ within the first specified size range SR¹ is at least 50 wt. % of the total mass m¹ of the first particles 122A, for example at least 55 wt. wt. %, at least 60 wt. %, at least 65 wt. %, at least 70 wt. %, at least 71 wt. %, at least 72 wt. %, at least 73 wt. %, at least 74 wt. %, at least 75 wt. %, at least 76 wt. %, at least 77 wt. %, at least 78 wt. %, at least 79 wt. %, at least 80 wt. %, at least 81 wt. %, at least 82 wt. %, at least 83 wt. %, at least 84 wt. %, at least 85 wt. %, at least 86 wt. %, at least 87 wt. %, at least 88 wt. %, at least 89 wt. %, at least 90 wt. %, at least 91 wt. %, at least 92 wt. %, at least 93 wt. %, at least 94 wt. %, at least 95 wt. %, at least 96 wt. %, at least 97 wt. %, at least 98 wt. %, at least 99 wt. %, at least 99.5 wt. %, at least 99.9 wt. %, or at least 99.99 wt. % of the total mass m¹ of the first particle group 130.

In an example, the first size range SR¹ can be defined as a range extending from a specified minimum particle size D^{SR1}_{Min} to a specified maximum particle size D^{SR1}_{Max}, e.g., the first size range SR¹ includes any first particles 122A having a size D¹ of from D^{SR1}_{Min} to D^{SR1}_{Max} (i.e., wherein D^{SR1}_{Min}≤D¹≤D^{SR1}_{Max}). The specified minimum size D^{SR1}_{Min} and maximum size D^{SR1}_{Max} of the first size range SR¹ are not necessarily the actual smallest and largest sizes of the first particle group 130. Rather, they simply represent the desired or specified end points of the first size range SR¹ in which a specified portion of the first particles 122A fall.

The specified minimum size D^{SR1}_{Min} and the specified maximum size D^{SR1}_{Max} for the first size range SR¹ can be defined in relation to another parameter. For example, one or both of the specified minimum size D^{SR1}_{Min} and the specified maximum particle size D^{SR1}_{Max} for the first size range SR¹ can be defined in relation to the median particle size D¹_{Med} of the first particle group 130. In an example, the specified minimum size D^{SR1}_{Min} is defined as being a specified percentage X^{SR1}_{Min} % of the first median particle size D¹_{Med} (e.g., D^{SR1}_{Min}=X^{SR1}_{Min} %×D¹_{Med}) and the specified maximum particle size D^{SR1}_{Max} is defined as being a specified percentage X^{SR1}_{Max} % of the first median particle size D¹_{Med} (e.g., D^{SR1}_{Max}=X^{SR1}_{Max} %×D¹_{Med}).

In one example, both the specified minimum size D^{SR1}_{Min} and the maximum size D^{SR1}_{Max} for the first size range SR¹ can be defined as a variance (Var^{SR1}_{Min} and Var^{SR1}_{Max}, respectively) away from the first median D¹_{Med}, e.g., such that D^{SR1}_{Min}=D¹_{Med}−Var^{SR1}_{Min} and D^{SR1}_{Max}=D¹_{Med}+Var^{SR1}_{Max}. The variance Var^{SR1}_{Min} for the specified minimum size D^{SR1}_{Min} can be equal to or different from the variance Var^{SR1}_{Max} for the specified minimum size D^{SR1}_{Max}. In an example, one or both of the variances Var^{SR1}_{Min} and Var^{SR1}_{Max} is defined as a specified variance percentage (Var %¹_{Min} or Var %¹_{Max}) of the first median particle size D¹_{Med}, e.g., such that D^{SR1}_{Min}=D¹_{Med}−Var %¹_{Min}×D¹_{Med}=(1−Var %¹_{Min})×D¹_{Med} and D^{SR1}_{Max}=D¹Avg+Var %¹_{Max}×D¹_{Med}=(1+Var %¹_{Max})×D¹_{Med}. For example, one or both of the first specified minimum and maximum particle sizes D^{SR1}_{Min} and D^{SR1}_{Max} can be defined as being within a specified amount from the first median particle size D¹_{Med}, which can be defined as a specified percentage Var %¹_{Min} and Var %¹_{Max} of the first median particle size D¹_{Med}. For example, one or both of the minimum and maximum particle sizes D^{SR1}_{Min} and D^{SR1}_{Max} for the first specified particle size range SR¹ can be defined as being no more than 10% of the first median particle size D¹_{Med} away from the value of the first median particle size D¹_{Med}, e.g., so that the first specified minimum particle size D^{SR1}_{Min} is about 90% of the first median particle size D¹_{Med} and/or so that the first specified maximum particle size D^{SR1}_{Max} is about 110% of the first median particle size D¹_{Med}.

In an example, the specified variance Var^{SR1}_{Min} and Var^{SR1}_{Max} that define the specified minimum and maximum sizes D^{SR1}_{Min} and D^{SR1}_{Max} are each 1 micrometer (μm) or less away from the first median particle size D¹_{Med}, for example 1 μm or less, 0.9 μm or less, 0.8 μm or less, 0.7 μm or less, 0.6 μm or less, 0.5 μm or less, 0.4 μm or less, 0.3 μm or less, 0.2 μm or less, or 0.1 μm or less.

In an example, the specified variance percentage Var %¹_{Min} and Var %¹_{Max} that define the specified minimum and maximum sizes D^{SR1}_{Min} and D^{SR1}_{Max} are each 20% or less of the first median particle size D¹_{Med}, for example 19.5% or less, 19% or less, 18.5% or less, 18% or less, 17.5% or less, 17% or less, 16.5% or less, 16% or less, 15.5% or less, 15% or less, 14.5% or less, 14% or less, 13.5% or less, 13% or less, 12.5% or less, 12% or less, 11.5% or less, 11% or less, 10.5% or less, 10% or less, 9.9% or less, 9.8% or less, 9.7% or less, 9.6% or less, 9.5% or less, 9.4% or less, 9.3% or less, 9.2% or less, 9.1% or less, 9% or less, 8.9% or less, 8.8% or less, 8.7% or less, 8.6% or less, 8.5% or less, 8.4% or less, 8.3% or less, 8.2% or less, 8.1% or less, 8% or less, 7.9% or less, 7.8% or less, 7.7% or less, 7.6% or less, 7.5% or less, 7.4% or less, 7.3% or less, 7.2% or less, 7.1% or less, 7% or less, 6.9% or less, 6.8% or less, 6.7% or less, 6.6% or less, 6.5% or less, 6.4% or less, 6.3% or less, 6.2% or less, 6.1% or less, 6% or less, 5.9% or less, 5.8% or less, 5.7% or less, 5.6% or less, 5.5% or less, 5.4% or less, 5.3% or less, 5.2% or less, 5.1% or less, 5% or less, 4.9% or less, 4.8% or less, 4.7% or less, 4.6% or less, 4.5% or less, 4.4% or less, 4.3% or less, 4.2% or less, 4.1% or less, 4% or less, 3.9% or less, 3.8% or less, 3.7% or less, 3.6% or less, 3.5% or less, 3.4% or less, 3.3% or less, 3.2% or less, 3.1% or less, 3% or less, 2.9% or less, 2.8% or less, 2.7% or less, 2.6% or less, 2.5% or less, 2.4% or less, 2.3% or less, 2.2% or less, 2.1% or less, 2% or less, 1.9% or less, 1.8% or less, 1.7% or less, 1.6% or less, 1.5% or less, 1.4% or less, 1.3% or less, 1.2% or less, 1.1% or less, 1% or less, 0.9% or less, 0.8% or less, 0.7% or less, 0.6% or less, 0.5% or less, 0.4% or less, 0.3% or less, 0.2% or less, or 0.1% of the first median particle size D¹_{Med}.

In an example, at least a second specified portion of the second particle group 134 has a particle size D² that is within a second specified particle size range SR² (which may also be referred to as the “second particle size range SR²” or simply the “second size range SR²”). The second specified portion of the second particle group 134 that falls within the second size range SR² can be equal to the first specified portion of the first particle group 130 that falls within the first size range SR¹, or the second specified portion of the second particle group 134 that falls within the second size range SR² can be different from the first specified portion of the first particle group 130 that falls within the first size range SR¹.

In an example, the second specified portion of the second particle group 134 that is within the second size range SR² is defined as a number percentage, e.g., expressed as X % of the total number N² of the second particles 122B in the second particle group 134 that are within the second size range SR². In an example, a number percentage value for the second specified portion of the second particle group 134 having a particle size D² within the second specified size range SR² is at least 50% of the total number N² of the second particles 122B, for example at least 55%, at least 60%, at least 65%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.9%, or at least 99.99% of the total number N² of the second particles 122B in the second particle group 134.

In another example, the second specified portion of the second particle group 134 that is within the second size range SR² is defined as a weight percentage, e.g., expressed as X wt. % of the total mass m² of the second particles 122B in the second particle group 134. In an example, a weight percentage value for the second specified portion of the second particle group 134 having a particle size D² within the second specified size range SR² is at least 50 wt. % of the total mass m² of the second particles 122B, for example at least 55 wt. wt. %, at least 60 wt. %, at least 65 wt. %, at least 70 wt. %, at least 71 wt. %, at least 72 wt. %, at least 73 wt. %, at least 74 wt. %, at least 75 wt. %, at least 76 wt. %, at least 77 wt. %, at least 78 wt. %, at least 79 wt. %, at least 80 wt. %, at least 81 wt. %, at least 82 wt. %, at least 83 wt. %, at least 84 wt. %, at least 85 wt. %, at least 86 wt. %, at least 87 wt. %, at least 88 wt. %, at least 89 wt. %, at least 90 wt. %, at least 91 wt. %, at least 92 wt. %, at least 93 wt. %, at least 94 wt. %, at least 95 wt. %, at least 96 wt. %, at least 97 wt. %, at least 98 wt. %, at least 99 wt. %, at least 99.5 wt. %, at least 99.9 wt. %, or at least 99.99 wt. % of the total mass m² of the second particle group 134.

In an example, the second size range SR² can be defined as a specific range from a specified minimum particle size D^{SR2}_{Min} to a specified maximum particle size D^{SR2}_{Max} for the second size range SR², e.g., the second size range SR² includes any second particles 122B having a size D² of from D^{SR2}_{Min} to D^{SR2}_{Max} (i.e., wherein D^{SR2}_{Min}≤D²≤D^{SR2}_{Max}). Similar to the specified minimum and maximum sizes D^{SR1}_{Min} and D^{SR1}_{Max} of the first size range SR¹, the specified minimum size D^{SR2}_{Min} and maximum size D^{SR2}_{Max} of the second size range SR² are not necessarily the actual smallest and largest sizes of the second particle group 134. Rather, they simply represent the desired or specified end points of the second size range SR² in which a specified portion of the second particles 122B fall.

The specified minimum size D^{SR2}_{Min} and the specified maximum size D^{SR2}_{Max} for the second size range SR² can be defined in relation to another parameter. For example, one or both of the specified minimum size D^{SR2}_{Min} and the specified maximum particle size D^{SR2}_{Max} for the second size range SR² can be defined in relation to the median particle size D²_{Med} of the second particle group 134. Or, in another example, one or both of the specified minimum size D^{SR2}_{Min} and the specified maximum size D^{SR2}_{Max} can be defined in relation to the median particle size D¹_{Med} of the first particle group 130. In an example, the specified minimum size D^{SR2}_{Min} is defined as being a specified percentage X^{SR2}_{Min} % of the second median particle size D²_{Med} (e.g., D^{SR2}_{Min}=X^{SR2}_{Min} %×D²_{Med}) and the specified maximum particle size D^{SR2}_{Max} is defined as being a specified percentage X^{SR2}_{Max} % of the second median particle size D²_{Med} (e.g., D^{SR2}_{Max}=X^{SR2}_{Max} %×D²_{Med}). The specified percentage X^{SR2}_{Min} % of the second median particle size D²_{Med} that defines the specified minimum particle size D^{SR2}_{Min} can be equal to the specified percentage X^{SR1}_{Min} % of the first median particle size D¹_{Med}, that defines the specified minimum particle size D^{SR1}_{Min}, or the specified percentage X^{SR2}_{Min} % of the second median particle size D²_{Med} can be different from the specified percentage X^{SR1}_{Min} % of the first median particle size D¹_{Med}. Similarly, the specified percentage X^{SR2}_{Max} % of the second median particle size D²_{Med} that defines the specified maximum particle size D^{SR2}_{Max} can be equal to the specified percentage X^{SR1}_{Max} % of the first median particle size D¹_{Med} that defines the specified maximum particle size D^{SR1}_{Max}, or the specified percentage X^{SR2}_{Max} % of the second median particle size D²_{Med} can be different from the specified percentage X^{SR1}_{Max} % of the first median particle size D¹_{Med}.

In one example, both the specified minimum size D^{SR2}_{Min} and the maximum size D^{SR2}_{Max} for the second size range SR² can be defined as a variance (Var^{SR2}_{Min} and Var^{SR2}_{Max}, respectively) away from the second median particle size D²_{Med}, e.g., such that D^{SR2}_{Min}=D²_{Med}−Var^{SR2}_{Min} and D^{SR2}_{Max}=D²_{Med}+Var^{SR2}_{Max}. The variance Var^{SR2}_{Min} for the specified minimum size D^{SR2}_{Min} can be equal to or different from the variance Var^{SR2}_{Max} for the specified minimum size D^{SR2}_{Max}. In an example, one or both of the variances Var^{SR2}_{Min} and Var^{SR2}_{Max} is defined as a specified variance percentage (Var %²_{Min} or Var %²_{Max}) of the first median particle size D¹_{Med}, e.g., such that D^{SR2}_{Min}=D²_{Med}−Var %²_{Min}×D¹_{Med} and D^{SR2}_{Max}=D²_{Med}+Var %²_{Max}×D¹_{Med}. The variances Var^{SR2}_{Min} and Var^{SR2}_{Max} from the second median particle size D²_{Med} that defines the specified minimum and maximum particle sizes D^{SR2}_{Min} and D^{SR2}_{Max} for the second particle size range SR² can be equal to or different from the variance Var^{SR1}_{Min} and Var^{SR1}_{Max} from the first median particle size D¹_{Med} that defines the specified minimum and maximum sizes D^{SR1}_{Min} and D^{SR1}_{Max} for the first particle size range SR¹. Similarly, the specified variance percentage Var %²_{Min} and Var %²_{Max} from the first median particle size D¹_{Med} that defines the specified minimum and maximum particle sizes D^{SR2}_{Min} and D^{SR2}_{Max} for the second particle size range SR² can be equal to or different from the variance percentage Var %¹_{Min} and Var %²_{Max} from the first median particle size D¹_{Med}, that defines the specified minimum and maximum sizes D^{SR1}_{Min} and D^{SR1}_{Max} for the first particle size range SR¹.

In an example, the specified variance Var^{SR2}_{Min} and Var^{SR2}_{Max} that define the specified minimum and maximum sizes D^{SR2}_{Min} and D^{SR2}_{Max} are each 1 μm or less away from the second median particle size D²_{Med}, for example 1 μm or less, 0.9 μm or less, 0.8 μm or less, 0.7 μm or less, 0.6 μm or less, 0.5 μm or less, 0.4 μm or less, 0.3 μm or less, 0.2 μm or less, or 0.1 μm or less.

In an example, the specified variance percentage Var % 2 that defines the specified minimum and maximum sizes D^{SR2}_{Min} and D^{SR2}_{Max} is 20% or less of the first median particle size D¹_{Med}, for example 19.5% or less, 19% or less, 18.5% or less, 18% or less, 17.5% or less, 17% or less, 16.5% or less, 16% or less, 15.5% or less, 15% or less, 14.5% or less, 14% or less, 13.5% or less, 13% or less, 12.5% or less, 12% or less, 11.5% or less, 11% or less, 10.5% or less, 10% or less, 9.9% or less, 9.8% or less, 9.7% or less, 9.6% or less, 9.5% or less, 9.4% or less, 9.3% or less, 9.2% or less, 9.1% or less, 9% or less, 8.9% or less, 8.8% or less, 8.7% or less, 8.6% or less, 8.5% or less, 8.4% or less, 8.3% or less, 8.2% or less, 8.1% or less, 8% or less, 7.9% or less, 7.8% or less, 7.7% or less, 7.6% or less, 7.5% or less, 7.4% or less, 7.3% or less, 7.2% or less, 7.1% or less, 7% or less, 6.9% or less, 6.8% or less, 6.7% or less, 6.6% or less, 6.5% or less, 6.4% or less, 6.3% or less, 6.2% or less, 6.1% or less, 6% or less, 5.9% or less, 5.8% or less, 5.7% or less, 5.6% or less, 5.5% or less, 5.4% or less, 5.3% or less, 5.2% or less, 5.1% or less, 5% or less, 4.9% or less, 4.8% or less, 4.7% or less, 4.6% or less, 4.5% or less, 4.4% or less, 4.3% or less, 4.2% or less, 4.1% or less, 4% or less, 3.9% or less, 3.8% or less, 3.7% or less, 3.6% or less, 3.5% or less, 3.4% or less, 3.3% or less, 3.2% or less, 3.1% or less, 3% or less, 2.9% or less, 2.8% or less, 2.7% or less, 2.6% or less, 2.5% or less, 2.4% or less, 2.3% or less, 2.2% or less, 2.1% or less, 2% or less, 1.9% or less, 1.8% or less, 1.7% or less, 1.6% or less, 1.5% or less, 1.4% or less, 1.3% or less, 1.2% or less, 1.1% or less, 1% or less, 0.9% or less, 0.8% or less, 0.7% or less, 0.6% or less, 0.5% or less, 0.4% or less, 0.3% or less, 0.2% or less, or 0.1% of the first median particle size D¹_{Med}.

In an example, the first particles 122A comprise at least a first specified percentage P¹ of the total particle population 120, which can be determined on a number basis (e.g., P¹=N¹/N_{Total}) or on a weight basis (e.g., P¹=m¹/m_{Total}). In an example, the first specified percentage P¹ of the total particle population 120 that is taken up by the first particles 122A, on a mass basis, is anywhere from about 0.1 wt. % to about 99.9 wt. % of the total particle population mass m_{Total}, for example at least 50 wt. % of the total particle population mass m_{Total} for the particulate composition, for example at least about 60 wt. % of the total particle population, for example at least 70 wt. % of the total particle population, for example at least 80 wt. % of the total particle population, for example at least 90 wt. % of the total particle population, for example at least 95 wt. % of the total particle population, for example at least 99 wt. % of the total particle population, for example at least 99.9 wt. % of the total particle population.

In an example, the second particles 122B comprise at least a second specified percentage P² of the total particle population 120, which can be determined on a number basis (e.g., P²=N²/N_{Total}) or on a weight basis (e.g., P²=m²/m_{Total}). The second specified percentage P² of the total particle population 120 taken up by the second particles 122B can be the same or different from the first specified percentage P¹ of the total particle population 120 taken up by the first particles 122A. In an example, the second specified percentage of the total particle population that is taken up by the second particles 122B, on a mass basis, anywhere from about 0.1 wt. % to about 99.9 wt. % of the total particle population mass m_{Total}, for example at least 0.1 wt. % of the total particle population for the particulate composition, for example at least 1 wt. % of the total particle population, for example at least 5 wt. % of the total particle population, for example at least 10 wt. % of the total particle population, for example at least 20 wt. % of the total particle population, for example at least 30 wt. % of the total particle population, for example at least 40 wt. % of the total particle population, for example at least 50 wt. % of the total particle population.

In an example, the sum of the first and second specified percentages (i.e., P¹+P²) taken up by the first and second particles 122A and 122B, respectively, is equal to at least 50 wt. % of the total mass m_{Total} of the particle population 120, for example at least about 55 wt. %, at least about 60 wt. %, at least about 70 wt. %, at least about 75 wt. %, at least about 80 wt. %, at least about 85 wt. %, at least about 90 wt. %, at least about 91 wt. %, at least about 92 wt. %, at least about 93 wt. %, at least about 94 wt. %, at least about 95 wt. %, at least about 96 wt. %, at least about 97 wt. %, at least about 98 wt. %, at least about 99 wt. %, at least about 99.5 wt. %, at least about 99.9 wt. %, at least about 99.99 wt. % of the total particle population, and in one example 100 wt. % of the total particle population mass m_{Total}.

The specified particulate composition 120 described above, e.g., with the bimodal particle size distribution 140, can have several advantages over previously-known electrode active material particulate compositions made from more monodisperse particles. Most notably, as discussed above, the specified bimodal distribution 140 can allow for more compact particle packing and improved mechanical stability for the particulate composition 120 compared to conventional monodisperse particulate compositions.

For example, a conventional monodisperse particulate composition of a lithium-based layered oxide cathode active material or lithium-based spinel oxide with a median particle size of from about 1 μm to about 20 μm and a monodisperse or substantially monodisperse particle size distribution have been known to have a tapped density of from about 2 grams per cubic centimeter (g/cm³) to about 2.3 g/cm³, for example from about 2.2 g/cm³ to about 2.3 g/cm³. Additionally, conventional olivine-type lithium-based cathode materials, such as LiFePO₄ or Li(FeₓMn₁₋ₓ)PO₄, have been known to have a tapped density of from about 0.5 g/cm³ to about 1.2 g/cm³. However, the particulate composition 120 described herein with a bimodal distribution 140 provided by mixing the two particle groups 130, 134, wherein the first median particle size D¹_{Med} of the first particle group 130 is at least 1.5 times as large as the second median particle size D²_{Med} of the second particle group 134, can result in the particulate composition 120 having a tapped density of at least about 2.3 g/cm³, when composed entirely of lithium-based layered oxide materials or lithium-based spinel oxide materials. When the particle composition is composed of lithium-based layered oxide materials mixed with other lithium-based cathode materials, such as olivine-type lithium-based cathode materials, the tapped density may be at least about 2.0 g/cm³. For example, the tapped density of the bimodal distribution may be from about 2.3 g/cm³ to about 3.5 g/cm³, such as from about 2.7 g/cm³ to about 3 g/cm³, for example from about 2.7 g/cm³ to about 2.8 g/cm³. Example values for the tapped density of the particulate composition 120 with the bimodal distribution 140 includes, but is not limited to: about 2.0 g/cm³, about 2.02 g/cm³, about 2. g/cm³, about 2.06 g/cm³, about 2.08 g/cm³, about 2.10 g/cm³, about 2.12 g/cm³, about 2.14 g/cm³, about 2.16 g/cm³, about 2.18 g/cm³, about 2.20 g/cm³, about 2.22 g/cm³, about 2.24 g/cm³, about 2.26 g/cm³, about 2.28 g/cm³, about 2.30 g/cm³, about 2.32 g/cm³, about 2.34 g/cm³, about 2.36 g/cm³, about 2.38 g/cm³, about 2.4 g/cm³, about 2.42 g/cm³, about 2.44 g/cm³, about 2.46 g/cm³, about 2.48 g/cm³, about 2.5 g/cm³, about 2.52 g/cm³, about 2.54 g/cm³, about 2.56 g/cm³, about 2.58 g/cm³, about 2.6 g/cm³, about 2.62 g/cm³, about 2.64 g/cm³, about 2.66 g/cm³, about 2.68 g/cm³, about 2.7 g/cm³, about 2.72 g/cm³, about 2.74 g/cm³, about 2.76 g/cm³, about 2.78 g/cm³, about 2.8 g/cm³, about 2.82 g/cm³, about 2.84 g/cm³, about 2.86 g/cm³, about 2.88 g/cm³, about 2.9 g/cm³, about 2.92 g/cm³, about 2.94 g/cm³, about 2.96 g/cm³, about 2.98 g/cm³, about 3 g/cm³, about 3.02 g/cm³, about 3.04 g/cm³, about 3.06 g/cm³, about 3.08 g/cm³, about 3.1 g/cm³, about 3.12 g/cm³, about 3.14 g/cm³, about 3.16 g/cm³, about 3.18 g/cm³, about 3.2 g/cm³, about 3.22 g/cm³, about 3.24 g/cm³, about 3.26 g/cm³, about 3.28 g/cm³, about 3.3 g/cm³, about 3.35 g/cm³, about 3.4 g/cm³, about 3.5 g/cm³, or a range with any two of these values as the endpoints.

The packing density of a material may be measured by applying a force over a given area of material, also described as pressure. For example, applying a specified applied pressure of 255 MPa to the present particulate composition 120 described herein with a bimodal distribution 140 provided by mixing the two particle groups 130, 134 can result in a pressed density of from about 3 g/cm³ to about 4.4 g/cm³, such as about 3 g/cm³, 3.1 g/cm³, 3.2 g/cm³, 3.3 g/cm³, 3.4 g/cm³, 3.5 g/cm³, 3.6 g/cm³, 3.7 g/cm³, 3.8 g/cm³, 3.9 g/cm³, 4.0 g/cm³, 4.1 g/cm³, 4.2 g/cm³, 4.3 g/cm³, or 4.4 g/cm³. Furthermore, the mechanical stability of a material may be measured by determining the extent of particle cracking after applying a force over a given area of material. For example, applying a specified applied pressure of 255 MPA to the present particulate composition 120 described herein with a bimodal distribution 140 may result in a lower extent of particle cracking than the extent of cracking exhibited by any of the monodispersed particle groups of which the bimodal distribution is composed.

The benefits of the particulate composition 120, described above, may be influenced by the methods implemented for mixing the particle groups 130, 134. For example, combining the particle groups by shaking, stirring, blending, pressing, or grinding and for different lengths of time, velocities, or forces, may influence the resulting density or other metrics of the material. In one example, stirring two particle groups can result in lower tapped density than blending the two particle groups. In another example, blending two particle groups for three seconds can result in lower tapped density than blending the two particle groups for thirty seconds.

### Cathode Active Material

As mentioned above, the particle size distribution 140 for the particulate composition 120 can be specified for particles of electrode active material for one or more electrodes of a battery, such as a cathode active material to form a cathode electrode for a battery. As noted above, the electrode active material can be in the form of a particulate composition 120, e.g., as a particulate powder having the specified particle size distribution described herein. The particulate composition 120 can be coated onto a current collector, e.g., similar to the cathode current collector 108 and the cathode active material 110 in the electrochemical cell 100 shown in FIG. 1, such as via a slurry-based deposition or assembly techniques.

Lithium-based layered oxides have been and are expected to continue to be the cathode active material of choice for portable electronics and passenger electric cars at least through the next decade. Despite varying formulations these materials have historically universally included cobalt in significant amounts. Conventionally, cobalt has been deemed essential for performance and stability. However, as noted above, cobalt is a scarce metal with a vulnerable supply chain and has tended to have a high cost. In addition, cobalt mining has been known to result in unfavorable impact on the environment. In comparison, nickel, manganese, aluminum, iron, zinc, and many other metals and non-metals, are far more earth-abundant and available. These metals and non-metals are also much less geographically concentrated than cobalt.

In contrast to this conventional use of cobalt in commercially-available layered oxide cathode materials, the electrode active materials of the present disclosure provide for high energy content with low or zero cobalt usage. The electrode active materials described herein can, therefore, reduce the dependence on cobalt for commercial layered oxide cathodes for lithium-based batteries, which can lead to more secure supply chains, lower cost, and less adverse environmental impacts. In addition, through facile compositional tuning, the described cathode materials can offer higher gravimetric energy density, higher volumetric energy density, higher rate capability, higher first-cycle coulombic efficiency, longer operational lifetime over a wide temperature range, and/or better safety features under abuse conditions, in comparison to commercial layered oxide cathode materials. Further tuning can be achieved via modification of the particle size distribution of the particulate compositions made from the electrode active materials.

Since cobalt suppresses nickel and lithium anti-site defects (i.e., cation disorder) in layered oxides, cobalt elimination can adversely affect rate capability and operational lifetime of the cathode material. Advantageously, the active materials described herein have been found to mitigate these issues by incorporating a series of alternative metals and/or non-metals, besides nickel, which compensate for the reduction or elimination of cobalt. Advantageously, these alternative metals and non-metals can be incorporated easily through metal co-precipitation, lithiation calcination, and/or subsequent surface treatment.

A wide variety of compositions for the electrode active materials are contemplated for the particulate compositions described herein. In an example, a cathode active material is a lithium-based layered oxide, such as a lithium transition metal layered oxide. In an example, the lithium transition metal layered oxide has the general chemical formula [1]:

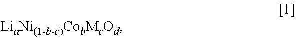

wherein M comprises one or more metals, such as one or more transition metals, one or more post-transition metals, one or more rare earth metals (e.g., one or more lanthanides, scandium (Sc), or yttrium (Y)), one or more alkaline earth metals, one or more alkali metals, and/or one or more non-metals. In an example, M comprises one or any combination of: manganese (Mn), aluminum (Al), magnesium (Mg), iron (Fe), chromium (Cr), boron (B), titanium (Ti), zirconium (Zr), gallium (Ga), zinc (Zn), vanadium (V), copper (Cu), ytterbium (Yb), sodium (Na), potassium (K), fluorine (F), barium (Ba), calcium (Ca), lutetium (Lu), yttrium (Y), niobium (Nb), molybdenum (Mo), ruthenium (Ru), rhodium (Rh), tantalum (Ta), promethium (Pr), tungsten (W), iridium (Ir), indium (In), thallium (TI), tin (Sn), strontium (Sr), sulfur(S), phosphorus (P), chlorine (Cl), germanium (Ge), antimony (Sb), erbium (Er), tellurium (Te), lanthanum (La), cerium (Ce), neodymium (Nd), dysprosium (Dy), europium (Eu), scandium (Sc), selenium (Se), silicon (Si), technetium (Tc), palladium (Pd), promethium (Pm), samarium (Sm), gadolinium (Gd), terbium (Tb), holmium (Ho), and thulium (Tm). For the electrode active materials described herein, M can optionally be one or a subset of the metals and non-metals identified above.

The subscript a in the chemical formula [1] represents the relative amount of lithium (Li) in the electrode active materials. With respect to its lithium content, the electrode active material can vary from so-called “lithium deficient” (or “Li-deficient”) to so-called “lithium rich” (or “Li-rich”). For example, the value of a can be from about 0.9 to about 1.1 in general, such as from about 0.9 to about 1 (which can be considered “Li-deficient”) or from about 1 to about 1.1 (which can be considered “Li-rich”). Example values of a in the chemical formula [1] include, but are not limited to, about 0.9, about 0.905, about 0.91, about 0.915, about 0.92, about 0.925, about 0.93, about 0.935, about 0.94, about 0.945, about 0.95, about 0.955, about 0.96, about 0.965, about 0.97, about 0.975, about 0.98, about 0.985, about 0.99, about 0.995, about 1, about 1.005, about 1.01, about 1.015, about 1.02, about 1.025, about 1.03, about 1.035, about 1.04, about 1.045, about 1.05, about 1.055, about 1.06, about 1.065, about 1.07, about 1.075, about 1.08, about 1.085, about 1.09, about 1.095, or about 1.1, or a range with any two of these values as the endpoints.

The subscript b in the chemical formula [1] represents the relative amount of cobalt (Co) in the electrode active material. As mentioned above, in an example, the amount of Co in the electrode active material is very low, e.g., such that the electrode active material is free or substantially free of Co. In an example, the term “free or substantially free of Co” means that the value of b in chemical formula [1] is about 0.05 or less (down to 0, or no Co), for example about 0.05 or less (down to 0, or no Co), such as 0.01 or less (down to 0, or no Co). Example values of b in the chemical formula [1] include, but are not limited to, 0 or about 0, about 0.005, about 0.01, about 0.015, about 0.02, about 0.025, about 0.03, about 0.035, about 0.04, about 0.045, about 0.05, about 0.055, about 0.06, about 0.065, about 0.07, about 0.075, about 0.08, about 0.085, about 0.09, about 0.095, or about 0.1, or a range with any two of these values as the endpoints.

The subscript c in the chemical formula [1] represents the relative amount of metal, metalloid, or non-metal in the electrode active material, represented by M in the chemical formula [1], with the understanding that “M” can actually be more than one of the specific elements listed above as examples for M. Ranges of values for c in the chemical formula [1] can vary fairly widely including, but not limited to, from about 0 to about 0.67, such as from about 0 to about 0.1, from about 0 to about 0.5, from about 0.1 to about 0.2, from about 0.2 to about 0.4, or from about 0.1 to about 0.5. Since M can correspond to one or multiple metals, metalloids, and/or non-metals, it will be appreciated that the stoichiometric coefficients for all of the individual metals, metalloids, and non-metals present will total to c. Example values for c (either for any individual one of the metals, metalloids, or non-metals, or collectively for all of the metals, metalloids, or non-metals) in the chemical formula [1] include, but are not limited to, about 0, about 0.005, about 0.01, about 0.015, about 0.02, about 0.025, about 0.03, about 0.035, about 0.04, about 0.045, about 0.05, about 0.055, about 0.06, about 0.065, about 0.07, about 0.075, about 0.08, about 0.085, about 0.09, about 0.095, about 0.10, about 0.105, about 0.11, about 0.115, about 0.12, about 0.125, about 0.13, about 0.135, about 0.14, about 0.145, about 0.15, about 0.155, about 0.16, about 0.165, about 0.17, about 0.175, about 0.18, about 0.185, about 0.19, about 0.195, about 0.20, about 0.205, about 0.21, about 0.215, about 0.22, about 0.225, about 0.23, about 0.235, about 0.24, about 0.245, about 0.25, about 0.255, about 0.26, about 0.265, about 0.27, about 0.275, about 0.28, about 0.285, about 0.29, about 0.295, about 0.30, about 0.305, about 0.31, about 0.315, about 0.32, about 0.325, about 0.33, about 0.335, about 0.34, about 0.345, about 0.35, about 0.355, about 0.36, about 0.365, about 0.37, about 0.375, about 0.38, about 0.385, about 0.39, about 0.395, about 0.40, about 0.405, about 0.41, about 0.415, about 0.42, about 0.425, about 0.43, about 0.435, about 0.44, about 0.445, about 0.45, about 0.455, about 0.46, about 0.465, about 0.47, about 0.475, about 0.48, about 0.485, about 0.49, about 0.495, about 0.50, about 0.505, about 0.51, about 0.515, about 0.52, about 0.525, about 0.53, about 0.535, about 0.54, about 0.545, about 0.55, about 0.555, about 0.56, about 0.565, about 0.57, about 0.575, about 0.58, about 0.585, about 0.59, about 0.595, about 0.60, about 0.605, about 0.61, about 0.615, about 0.62, about 0.625, about 0.63, about 0.635, about 0.64, about 0.645, about 0.65, about 0.655, about 0.66, about 0.665, about 0.666, about 0.667, about 0.668, about 0.669, or about 0.67, or a range with any two of these values as the endpoints.

The subscript d in the chemical formula [1] represents the relative amount of oxygen (O) in the electrode active material. With respect to its oxygen content, the electrode active material can vary from so-called “oxygen deficient” (or “O-deficient”) to so-called “oxygen rich” (or “O-rich”). For example, values of d from about 1.9 to less than 2 can be considered “O-deficient” and values from about 2 to about 2.1 can be considered “O-rich.” Ranges of values for d in the chemical formula [1] include, but are not limited to, from about 1.9 to about 2.1, such as from about 1.95 to about 2.05, from about 1.9 to about 1.95, from about 1.95 to about 2, from about 1.9 to about 2, from about 2 to about 2.05, from about 2.05 to about 2.1, or from about 2 to about 2.1. Example values of d in the chemical formula [1] include, but are not limited to, about 1.9, about 1.905, about 1.91, about 1.915, about 1.92, about 1.925, about 1.93, about 1.935, about 1.94, about 1.945, about 1.95, about 1.955, about 1.96, about 1.965, about 1.97, about 1.975, about 1.98, about 1.985, about 1.99, about 1.995, about 2, about 2.005, about 2.01, about 2.015, about 2.02, about 2.025, about 2.03, about 2.035, about 2.04, about 2.045, about 2.05, about 2.055, about 2.06, about 2.065, about 2.07, about 2.075, about 2.08, about 2.085, about 2.09, about 2.095, or about 2.1, or a range with any two of these values as the endpoints.

The subscript 1-b-c in the chemical formula [1] represents the relative amount of nickel (Ni) in the electrode active material. In general, the amount of Ni can vary from relatively low to relatively high. In some examples, the relative amount of Ni can be dependent upon the amount of Co and/or the total amount of the metal or non-metal M in the electrode active material. Ranges of values for 1-b-c in the chemical formula [1] include, but are not limited to, from about 0.33 to about 1, such as from about 0.5 to about 1. Example values for 1-b-c in the chemical formula [1] include, but are not limited to, about 0.33, about 0.333, about 0.334, about 0.335, about 0.34, about 0.345, about 0.35, about 0.355, about 0.36, about 0.365, about 0.37, about 0.375, about 0.38, about 0.385, about 0.39, about 0.395, about 0.40, about 0.405, about 0.41, about 0.415, about 0.42, about 0.425, about 0.43, about 0.435, about 0.44, about 0.445, about 0.45, about 0.455, about 0.46, about 0.465, about 0.47, about 0.475, about 0.48, about 0.485, about 0.49, about 0.495, about 0.50, about 0.505, about 0.51, about 0.515, about 0.52, about 0.525, about 0.53, about 0.535, about 0.54, about 0.545, about 0.55, about 0.555, about 0.56, about 0.565, about 0.57, about 0.575, about 0.58, about 0.585, about 0.59, about 0.595, about 0.60, about 0.605, about 0.61, about 0.615, about 0.62, about 0.625, about 0.63, about 0.635, about 0.64, about 0.645, about 0.65, about 0.655, about 0.66, about 0.665, about 0.67, about 0.675, about 0.68, about 0.685, about 0.69, about 0.695, about 0.70, about 0.705, about 0.71, about 0.715, about 0.72, about 0.725, about 0.73, about 0.735, about 0.74, about 0.745, about 0.75, about 0.755, about 0.76, about 0.765, about 0.77, about 0.775, about 0.78, about 0.785, about 0.79, about 0.795, about 0.80, about 0.805, about 0.81, about 0.815, about 0.82, about 0.825, about 0.83, about 0.835, about 0.84, about 0.845, about 0.85, about 0.855, about 0.86, about 0.865, about 0.87, about 0.875, about 0.88, about 0.885, about 0.89, about 0.895, about 0.90, about 0.905, about 0.91, about 0.915, about 0.92, about 0.925, about 0.93, about 0.935, about 0.94, about 0.945, about 0.95, about 0.955, about 0.96, about 0.965, about 0.97, about 0.975, about 0.98, about 0.985, about 0.99, about 0.995, or about 1, or a range with any two of these values as the endpoints.

In an example, the electrode active materials described herein can exhibit higher gravimetric energy density than a comparative electrode active material with a non-bimodal particle size distribution (e.g., wherein the particle sizes are only the first particles 122A of the first particle group 130 or only the second particles 122B of the second particle group 134), which is the amount of energy stored by the electrode active material per unit mass. In an example, the electrode active materials exhibit or are characterized by a gravimetric energy density for a single discharge of from about 600 watt-hours per kilogram (Wh·kg⁻¹) to about 1000 Wh·kg⁻¹, such as from about 625 Wh·kg⁻¹ to about 1000 Wh·kg⁻¹, for example from about 650 Wh·kg⁻¹ to about 1000 Wh·kg⁻¹, such as from about 675 Wh·kg⁻¹ to about 1000 Wh·kg⁻¹, for example from about 700 Wh·kg⁻¹ to about 1000 Wh·kg⁻¹, such as from about 725 Wh·kg⁻¹ to about 1000 Wh·kg⁻¹, for example from about 750 Wh·kg⁻¹ to about 1000 Wh·kg⁻¹, such as from about 775 Wh·kg⁻¹ to about 1000 Wh·kg⁻¹, for example from about 800 Wh·kg⁻¹ to about 1000 Wh·kg⁻¹, such as from about 825 Wh·kg⁻¹ to about 1000 Wh·kg⁻¹, for example from about 850 Wh·kg⁻¹ to about 1000 Wh·kg⁻¹, such as from about 875 Wh·kg⁻¹ to about 1000 Wh·kg⁻¹, for example from about 900 Wh·kg⁻¹ to about 1000 Wh·kg⁻¹, such as from about 925 Wh·kg⁻¹ to about 1000 Wh·kg⁻¹, for example from about 950 Wh·kg⁻¹ to about 1000 Wh·kg⁻¹, or from about 975 Wh·kg⁻¹ to about 1000 Wh·kg⁻¹.

The gravimetric energy density can correspond to a discharge from about 5 V to about 3 V vs. Li⁺/Li, such as from about 4.4 V to about 3 V vs. Li⁺/Li. Those having skill in the art will appreciate that some electrode active materials can discharge to lower voltages, such as 2 V vs. Li⁺/Li, which can allow those electrode active materials to exhibit specific energies that are higher than if they were only discharged to 3 V vs. Li⁺/Li or greater, in some cases substantially higher. Similarly, some electrode active materials can be charged to voltages higher than about 5 V vs. Li⁺/Li, providing some additional energy. For comparison purposes, discharging from a voltage higher than about 5 V vs. Li⁺/Li or to a voltage lower than about 3 V vs. Li⁺/Li may not provide the same information as a discharge from about 5 V to about 3 V vs. Li⁺/Li.

The gravimetric energy density can correspond to a discharge at a particular temperature, such as room temperature, or about 25° C. It will be appreciated that some electrode active materials can exhibit different specific energies and rate capabilities at different temperatures.

The gravimetric energy density can correspond to a discharge at a particular discharge rate, such as 1 C or C/10. It will be appreciated that some electrode active materials can exhibit different specific energies when discharged at different rates.

In an example, the gravimetric energy density for a single discharge can correspond to a discharge from about 5 V to about 3.1 V vs. Li⁺/Li, such as from about 5 V to about 3.2 V vs. Li⁺/Li, for example from about 5 V to about 3.3 V vs. Li⁺/Li, such as from about 5 V to about 3.4 V vs. Li⁺/Li, for example from about 5 V to about 3.5 V vs. Li⁺/Li, such as from about 4.9 V to about 3 V vs. Li⁺/Li, for example from about 4.8 V to about 3 V vs. Li⁺/Li, such as from about 4.7 V to about 3 V vs. Li⁺/Li, for example from about 4.6 V to about 3 V vs. Li⁺/Li, such as from about 4.5 V to about 3 V vs. Li⁺/Li, for example from about 4.4 V to about 3 V vs. Li⁺/Li.

The electrode active materials described herein can provide for a higher gravimetric energy density that is retained after a larger number of charge-discharge cycles than the comparative electrode active material with a non-bimodal particle size distribution (e.g., wherein the particle sizes are only the first particles 122A of the first particle group 130 or only the second particles 122B of the second particle group 134). In some cases, the gravimetric energy density can decrease as a function of the number of charge-discharge cycles. The electrode active materials described herein can exhibit a specified operational lifetime that is acceptable for commercial applications. In an example, the acceptable operational lifetime is defined as an acceptable degradation of the gravimetric energy density of the electrode active material after specified number charge-discharge cycles—e.g., the percentage decrease in the gravimetric energy density exhibited by the electrode active material after the specified number of cycles compared to its original gravimetric energy density. In an example, the electrode active material has a gravimetric energy density degradation of no more than about 20% after 500 charge-discharge cycles, for example no more than about 15% after 500 charge-discharge cycles, such as no more than about 10% after 500 charge-discharge cycles. In an example, the electrode active material has a gravimetric energy density degradation of no more than about 20% after 1000 charge-discharge cycles, for example no more than about 15% after 1000 charge-discharge cycles, such as no more than about 10% after 1000 charge-discharge cycles. In an example, the electrode active material has a gravimetric energy density degradation of no more than about 20% after 100 charge-discharge cycles, for example no more than about 15% after 100 charge-discharge cycles, such as no more than about 10% after 100 charge-discharge cycles, such as no more than about 5% after 100 charge-discharge cycles, such as no more than about 2.5% after 100 charge-discharge cycles.

For example, the electrode active material can exhibit or be characterized by an original gravimetric energy density for a first discharge and a gravimetric energy density for another discharge after about 500 charge-discharge cycles after the first discharge that is at least about 80% of the original gravimetric energy density of from about 600 Wh·kg⁻¹ to about 1000 Wh·kg⁻¹. In an example, the gravimetric energy density for a discharge after about 1000 charge-discharge cycles after the first discharge can be at least about 80% of the original gravimetric energy density of from about 600 Wh·kg⁻¹ to about 1000 Wh·kg⁻¹. In an example, the gravimetric energy density for a discharge after about 500 charge-discharge cycles after the first discharge can be at least about 85% of the original gravimetric energy density, for example at least about 90% of the original gravimetric energy density, such as at least about 95% of the original gravimetric energy density of from about 600 Wh·kg⁻¹ to about 1000 Wh·kg⁻¹. In an example, the gravimetric energy density for a discharge after about 100 charge-discharge cycles after the first discharge can be at least about 95% of the original gravimetric energy density of from about 600 Wh·kg⁻¹ to about 1000 Wh·kg⁻¹. In an example, the electrode active material can exhibit or be characterized by an original gravimetric energy density for a first discharge of from about 600 Wh·kg⁻¹ to about 1000 Wh·kg⁻¹ and a gravimetric energy density for another discharge after about 500 charge-discharge cycles after the first discharge of from about 480 Wh·kg⁻¹ to about 1000 Wh·kg⁻¹. In an example, the electrode active material can exhibit or be characterized by an original gravimetric energy density for a first discharge of from about 600 Wh·kg⁻¹ to about 1000 Wh·kg⁻¹ and a gravimetric energy density for another discharge after about 1000 charge-discharge cycles after the first discharge of from about 480 Wh·kg⁻¹ to about 1000 Wh·kg⁻¹. In another example, the electrode active material can exhibit or be characterized by an original gravimetric energy density for a first discharge of from about 600 Wh·kg⁻¹ to about 1000 Wh·kg⁻¹ and a gravimetric energy density for another discharge after about 500 charge-discharge cycles from about 540 Wh·kg⁻¹ to about 1000 Wh·kg⁻¹. In another example, the electrode active material can exhibit or be characterized by an original gravimetric energy density for a first discharge of from about 600 Wh·kg⁻¹ to about 1000 Wh·kg⁻¹ and a gravimetric energy density for another discharge after 100 charge-discharge cycles after the first discharge of from about 570 Wh·kg⁻¹ to about 1000 Wh·kg⁻¹. These discharges for measuring a gravimetric energy density can be from about 5 V to about 3 V vs. Li⁺/Li, or from about 5 V to a voltage greater than about 3 V vs. Li⁺/Li, such as about 3.1 V, about 3.2 V, about 3.3 V, about 3.4 V, or about 3.5 V vs. Li⁺/Li, or from a voltage lower than about 5 V, such as about 4.9 V, about 4.8 V, about 4.7 V, about 4.6 V, about 4.5 V, or about 4.4 V, to about 3 V vs. Li⁺/Li.

In an example, the electrode active material can exhibit or be characterized by a gravimetric energy density for a 1 C discharge between about 5 V and about 3 V vs. Li⁺/Li at 25° C. that is from about 80% to about 100% of a gravimetric energy density for a C/10 discharge between about 5 V and about 3 V vs. Li⁺/Li at 25° C. As used herein, the recitation of a discharge between a range of two voltages can optionally include a discharge between a range of two intermediate voltages. For example, a discharge between about 5 V and about 3 V vs. Li⁺/Li can include a discharge from about 5 V to about 3 V vs. Li⁺/Li, from about 4 V to about 3 V vs. Li⁺/Li, from about 5 V to about 4 V vs. Li⁺/Li, from about 4.5 V to about 3 V vs. Li⁺/Li, from about 4.13 V to about 3.43 V vs. Li⁺/Li, etc. In some examples, the gravimetric energy density for the 1 C discharge between about 5 V and about 3 V vs. Li⁺/Li at 25° C. can be from about 85% to about 100% of the gravimetric energy density for a C/10 discharge between about 5 V and about 3 V vs. Li⁺/Li at 25° C. In some examples, the gravimetric energy density for the 1 C discharge between about 5 V and about 3 V vs. Li⁺/Li at 25° C. can be from 90% to about 100% of the gravimetric energy density for a C/10 discharge between about 5 V and about 3 V vs. Li⁺/Li at 25° C. In some examples, the gravimetric energy density for the 1 C discharge between about 5 V and about 3 V vs. Li⁺/Li at 25° C. can be from about 600 Wh·kg⁻¹ to about 1000 Wh·kg⁻¹. In some examples, the gravimetric energy density for the 1 C discharge between about 5 V and about 3 V vs. Li⁺/Li at 25° C. can be from about 750 Wh·kg⁻¹ to about 1000 Wh·kg⁻¹.

The electrode active materials described herein can exhibit high voltage during discharge, characterized by a dQ·dV⁻¹ curve exhibiting a minimum of high voltage during discharge (as described in more detail in U.S. Pat. No. 11,233,239, the disclosure of which is incorporated herein by reference in its entirety). In an example, the electrode active materials described herein exhibit a high voltage measured on a cathode level, such as from about 4.15 V to about 4.3 V vs. Li⁺/Li, at a minimum of from about −300 mAh·g⁻¹ V⁻¹ to about −3000 mAh·g⁻¹ V⁻¹, in a dQ·dV⁻¹ curve during discharge. Example high voltages can be from about 4.16 V to about 4.3 V vs. Li⁺/Li, from about 4.17 V to about 4.3 V vs. Li⁺/Li, from about 4.18 V to about 4.3 V vs. Li⁺/Li, from about 4.19 V to about 4.3 V vs. Li⁺/Li, from about 4.2 V to about 4.3 V vs. Li⁺/Li, from about 4.21 V to about 4.3 V vs. Li⁺/Li, or from about 4.22 V to about 4.3 V vs. Li⁺/Li. In some examples, the minimum in a dQ·dV⁻¹ curve during discharge is from about −400 mAh·g⁻¹ V⁻¹ or lower, for example, −500 mAh·g⁻¹ V⁻¹ or lower, −600 mAh·g⁻¹ V⁻¹ or lower, −700 mAh·g⁻¹ V⁻¹ or lower, −800 mAh·g⁻¹ V⁻¹ or lower, −900 mAh·g⁻¹ V⁻¹ or lower, −1000 mAh·g 1 V⁻¹ or lower, −1200 mAh·g⁻¹ V⁻¹ or lower, −1400 mAh·g⁻¹ V⁻¹ or lower, −1600 mAh·g⁻¹ V⁻¹ or lower, −1800 mAh·g⁻¹ V⁻¹ or lower, or −2000 mAh·g⁻¹ V⁻¹ or lower. The voltage can correspond to a method for calculation of the dQ·dV⁻¹ curves, such as a voltage sampling step of 0.02 V. It will be appreciated that some calculation methods may exhibit different voltages and/or minimums of different values expressed by mAh·g⁻¹ V⁻¹ in dQ·dV⁻¹ curves during discharge. The voltage can correspond to a discharge at a particular temperature, such as room temperature, 25° C. It will be appreciated that some electrode active materials may exhibit different voltages at different temperatures. The voltage can correspond to a discharge at a particular discharge rate, such as C/10. It will be appreciated that some electrode active materials may exhibit different voltages when discharged at different rates. The voltage can correspond to a discharge of an electrode of a particular composition and thickness, such as those comprising an electrode active material content of at least 90% by weight and an electrode active material areal capacity loading of at least 2.0 mAh·cm⁻². It will be appreciated that some electrode active materials may exhibit different voltages in electrodes of different compositions or thicknesses. The voltage can correspond to a discharge of an electrode in a particular battery cell configuration, such as a coin-format half battery cell paired with lithium metal as the counter electrode infused with a commercial non-aqueous electrolyte. It will be appreciated that some electrode active materials may exhibit different voltages in different battery cell configurations.

The electrode active materials can have various different physical or other properties, which can be different from those of other conventional materials. In an example, the crystal structure of the electrode active materials can also be distinct from other conventional materials. In an example, a portion of the electrode active material can comprise or be characterized by a rhombohedral crystal structure, such as a rhombohedral R3̅m crystal structure. In an example, the rhombohedral crystal structure or the rhombohedral R3̅m crystal structure can be or comprise a majority (e.g., about 50% or more by volume) of the electrode active material. The rhombohedral crystal structure or the rhombohedral R3̅m crystal structure can be about 50% or more by volume of the electrode active material, about 55% or more by volume of the electrode active material, about 60% or more by volume of the electrode active material, about 65% or more by volume of the electrode active material, about 70% or more by volume of the electrode active material, about 75% or more by volume of the electrode active material, about 80% or more by volume of the electrode active material, about 85% or more by volume of the electrode active material, about 90% or more by volume of the electrode active material, about 95% or more by volume of the electrode active material, or about 99% or more by volume of the electrode active material.

The particles that make up the particulate composition of the present disclosure can have differences between the surface of the particles and an interior or bulk of the particles. In an example, the particles of the electrode active material can have or be characterized by a surface region and a bulk region. In an example, the surface region corresponds to a first portion of the active material particles within 20% of a cross-sectional dimension from a surface of the active material particles, and wherein the bulk region corresponds to a second portion of the active material particles deeper than the surface region, i.e., more than 20% of the cross-sectional dimension from the surface.

In an example, the bulk region can be free or substantially free of or otherwise not exhibit a spinel (for example, P4₃32 and Fd3̅m) crystal structure, a lithium-excess (for example, C2/m) crystal structure, a polyanionic (for example, Pmnb/Pnma) crystal structure, or a rock-salt (for example, Fm3̅m) crystal structure. In an example, at least a portion of the surface region can comprise or be characterized by a spinel (for example, P4₃32 and Fd3̅m) crystal structure, a lithium-excess (for example, C2/m) crystal structure, a polyanionic (for example, Pmnb/Pnma) crystal structure, a rock-salt (for example, Fm3̅m) crystal structure, or a combination thereof.

Control over the morphology of particles comprising the electrode active material can be useful for achieving desirable properties, such as the example specific energies described above, the example rate capabilities described above, and/or the example operational lifetimes described above.

### Method of Making the Electrode Active Material

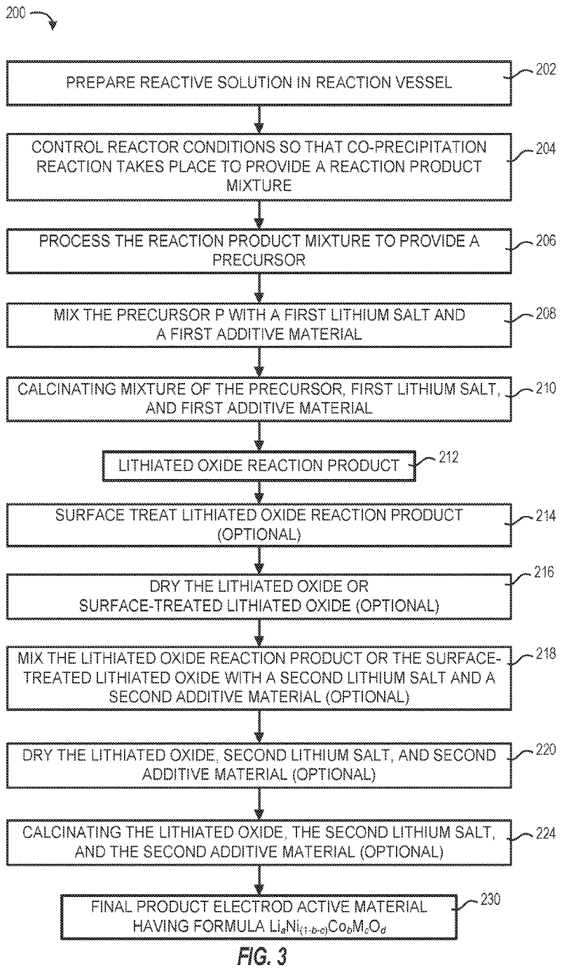

In an example, the electrode active material having the general chemical formula [1] are synthesized through metal co-precipitation and lithiation calcination. FIG. 3 is a flow diagram of an example of this process 200 of synthesizing the electrode active material of general chemical formula [1]. First, at step 202, a reactive solution is prepared in a reaction vessel. In an example, the reactive solution includes a mixed-metal aqueous solution, a pH-maintaining solution, and a chelating solution that are mixed together in the reaction vessel.

In an example, the mixed-metal aqueous solution comprises salts of nickel, cobalt (if present), and the one or more metals and/or non-metals of M dissolved into an aqueous solute at specified metal molar ratios, e.g., according to desired amounts to achieve the molar subscripts a, b, c, d and (1−b−c) in general chemical formula [1]. Examples of the metal or non-metal salts that are used to form the aqueous solution include, but are not limited to, nitrates, chlorides, acetates, sulfates, oxalates, and combinations thereof. In an example, the concentration of the mixed-metal ion aqueous solution can be from about 0.1 mole per liter (mol·L⁻¹) to about 3.0 mol·L⁻¹.

In an example, the pH-maintaining solution comprises a base, such as one or more of sodium hydroxide (NaOH), aqueous potassium hydroxide (KOH), aqueous sodium carbonate (Na₂CO₃), and aqueous potassium carbonate (K₂CO₃), wherein the concentration of the base in the pH-maintaining solution is selected to achieve a specified pH for the final reactive solution. In an example, the specified pH is from about 8 to about 12. In an example, the concentration of the base in the pH-maintaining solution is from about 0.2 mol·L⁻¹ to about 10 mol·L⁻¹.

In an example, the chelating solution comprises a specified amount of a chelating agent, such as an aqueous solution of ammonium hydroxide (NH₄OH), wherein the concentration of the chelating agent in the chelating solution is selected to provide the resulting reactive mixture having an appropriate concentration of the chelating agent inside the reaction vessel.

After the reactive mixture is formed (step 200), the process 200 includes, at 204, controlling various conditions within the reaction vessel, such as the temperature of the reactive mixture at specified values and/or agitating the reactive mixture at a specified stirring speed, so that a co-precipitation reaction takes place in order to produce a reaction product mixture. In an example, the controlled temperature that is part of step 204 is from about 30° C. to about 80° C. In an example, the agitation that is part of step 204 is at a stirring speed of from about 100 rpm to about 1000 rpm.

Next, the process 200 can include, at step 206, processing the reaction product mixture in the tank reactor to provide a dried precursor. In an example, the processing 206 of the reaction product mixture to provide the precursor includes one or more of filtering, washing, and drying the reaction product mixture. Then, at step 208, the process 200 includes mixing the dried precursor with specified amounts of a first lithium salt and a first additive material. In an example, the first lithium salt comprises one or more of lithium carbonate (Li₂CO₃), lithium hydroxide (LiOH), lithium acetate (C₂H₃LiO₂), lithium oxide (Li₂O), lithium oxalate (C₂Li₂O₄), and combinations thereof. In an example, the first additive material comprises salts of M, including but not limited to, oxides, carbonates, nitrates, acetates, oxalates, hydroxides, fluorides, isopropoxides, and combination thereof.

Next, the process 200 includes, at step 210, calcinating the mixture of the precursor, the first lithium salt, and the first additive material at a specified calcination temperature to obtain lithiated oxide reaction product particles 212. In an example, the calcination temperature for step 210 is from about 300° C. to about 1000° C., such as from about 600° C. to about 1000° C. In an example, the calcination step 210 can be for a calcination period of from about 1 minute to about 1200 minutes. The calcination 210 can be performed under a flowing gaseous atmosphere of an oxygen content from about 21% (air) to about 100% (pure oxygen).

In some examples, the lithiated oxide reaction product particles 212 after the calcination 210 is the final product having the chemical formula [1] (e.g., LiₐNi_{(1-b-c)}Co_{b}M_{c}O_{d}). In other examples, the process 200 can include further treatment of the lithiated oxide reaction product particles 212, such as by washing the particles in a solvent (such as at least one of water, ethanol, ethylene glycol, and isopropanol), treating the lithiated oxide reaction product particles 212 with one or more gases (such as at least one of: ammonia gas, sulfur dioxide gas, carbon dioxide gas, hydrogen phosphate gas, and acetylene gas), or coating the lithiated oxide reaction product particles 212 with a coating. Examples of coatings include a metal oxide coating or a metal phosphate coating. Examples of methods that can be used to form a metal oxide coating or a metal phosphate coating include, but are not limited to: atomic layer deposition, dry coating, and firing, Examples of metal oxides that can be coated onto the particles include, but are not limited to, at least one of: alumina, magnesium oxide, zirconium oxide zinc oxide, tungsten oxide, and boron oxide. Examples of metal phosphates that can be coated onto the particles include, but are not limited to, at least one of: lithium phosphate and aluminum phosphate. In an example, shown in FIG. 3, the process 200 further includes an optional step 214 of surface treating the lithiated oxide reaction product 212 to provide a surface-treated lithiated oxide.

Next, in an example, the process 200 optionally includes, at step 218, mixing the lithiated oxide reaction product 212 or the surface-treated lithiated oxide with a second lithium salt and a second additive material at appropriate molar ratios. In an example, the lithiated oxide can optionally be dried prior to mixing, for example at step 216 in FIG. 3. In another example, the lithiated oxide, the second lithium salt, and the second additive material can optionally be dried after mixing, for example at step 220 in FIG. 3. In an example, the second lithium salt comprises one or more of lithium carbonate (Li₂CO₃), lithium hydroxide (LiOH), lithium acetate (C₂H₃LiO₂), lithium oxide (Li₂O), lithium oxalate (C₂Li₂O₄), and combinations thereof. The second lithium salt (i.e., the lithium salt that is mixed with the lithiated oxide reaction product 212 or the surface treated reaction product resulting from step 214) can be the same or different from the first lithium salt (i.e., the lithium salt that is calcinated 210 with the precursor to provide the lithiated oxide reaction product 212). In an example, the second additive material comprises salts of M, including but not limited to, oxides, carbonates, nitrates, acetates, oxalates, hydroxides, fluorides, isopropoxides, and combination thereof. The second additive material of step 218 can be the same or different from the first additive material that is included for the calcination 210.

Finally, in some examples, the process 200 optionally includes, at step 224, calcinating the lithiated oxide reaction product 212 or the surface-treated lithiated oxide that results from step 214, the second lithium salt, and the second additive material at an elevated temperature to obtain the final product 230, e.g., an electrode active material 230 with the chemical formula [1] (e.g., LiₐNi_{(1-b-c)}CO_{b}M_{c}O_{d}), which can be used as the electrode active material in the particulate compositions and electrochemical cells described herein.

The synthesis of the electrode active material 230 having the chemical formula LiₐNi_{(1-b-c)}CO_{b}M_{c}O_{d} can be similar to established production methods, but it also has a series of advantages, such as: (i) precise control of metal co-precipitation of nickel and other metals and/or non-metals at appropriate molar ratios that enables homogenous mixing at the atomic scale, (ii) precise control of metal co-precipitation and lithiation calcination that enables fine tuning of the morphology and microstructure of the material secondary and primary particles, and (iii) an optional surface treatment that reduces residual lithium species and enhances surface stability of the material. It will be appreciated that the properties of lithium transition-metal layered oxides are extremely sensitive to their synthesis conditions. The synthesis described is useful for enabling the higher gravimetric energy density, higher volumetric energy density, higher rate capability, higher first-cycle coulombic efficiency, longer operational lifetime, and/or better safety of LiₐNi_{(1-b-c)}CO_{b}M_{c}O_{d}.

Further details of a cathode active material that can be used to form the particles with the particle size distribution and/or the particle packing configuration described herein are disclosed in U.S. Pat. No. 11,233,239 to Manthiram et al., issued on Jan. 25, 2022, entitled “LOW-COBALT AND COBALT-FREE, HIGH-ENERGY CATHODE MATERIALS FOR LITHIUM BATTERIES,” the disclosure of which is incorporated herein by reference in its entirety.

### EXAMPLES

Various embodiments of the present invention can be better understood by reference to the following Examples which are offered by way of illustration. The present invention is not limited to the Examples given herein.

### Example 1

Two particle size groups of a lithium-based layered oxide cathode material comprising LiNi_{0.9}Mn_{0.05}Al_{0.05}O₂ were prepared according to the methods described herein. Dissolvable salts of nickel, manganese, and aluminum were used to make aqueous solutions of the proper molar ratio at 2.0 mol·L⁻¹. The mixed-metal ion aqueous solution was pumped into a tank reactor at a controlled rate under nitrogen atmosphere. An aqueous solution of potassium hydroxide at 6.0 mol·L⁻¹ and ammonium hydroxide at 1.0 mol·L⁻¹ was separately pumped into the tank reactor to maintain a pH of 11.5±0.5. The co-precipitation reaction took place at 50±5° C. Particles were grown to an average diameter of 6.5 μm or 18.5 μm by running the reaction, and thereby dripping in more mixed-metal ion solution, for a shorter or longer amount of time, respectively. Subsequently, precursors comprising Ni_{0.9}Mn_{0.05}Al_{0.05}(OH)₂ were obtained through washing, filtering, and drying then mixed with lithium hydroxide at a molar ratio of 1:1±0.03. The mixed precursors and lithium hydroxide were calcined at 750±50° C. for 25±10 h under an oxygen atmosphere of a 2.75±2 liter per minute flow rate to obtain LiNi_{0.9}Mn_{0.05}Al_{0.05}O₂. It will be appreciated that the lithium and oxygen contents in these chemical compositions are based on stoichiometry, but the lithium and oxygen contents may deviate from their stoichiometric values.

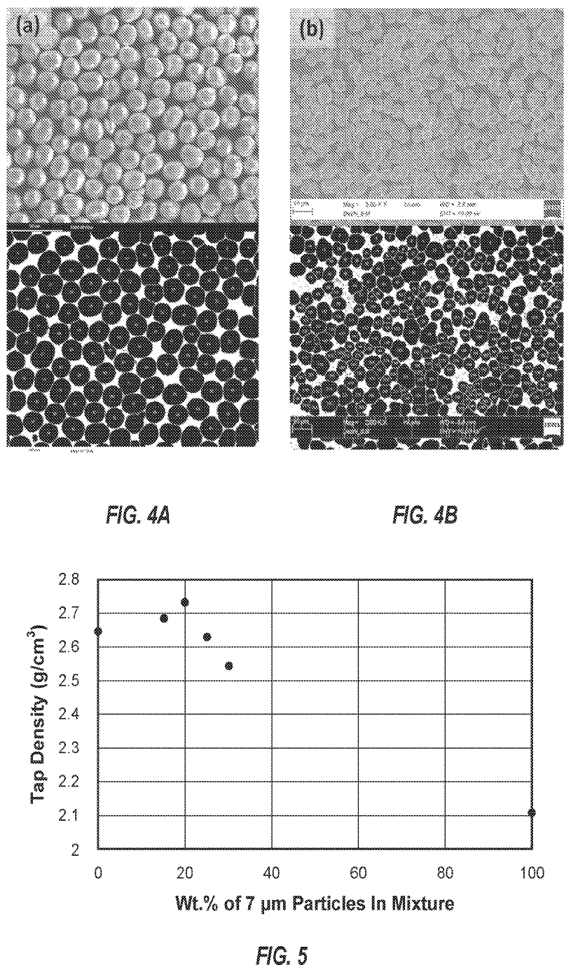

FIGS. 4A and 4B show scanning electron microscopy (SEM) images of the larger particle batch (FIG. 4A) and the smaller particle batch (FIG. 4B) of LiNi_{0.9}Mn_{0.05}Al_{0.05}O₂ particles. The images were processed using software to measure the particle size distribution (bottom halves of FIGS. 4A and 4B). The characteristics of the smaller and larger batches of the particles are shown in TABLE 1 below. D_{Med} is the median particle size of the particle population, D10 is the particle size in the lower 10% of the particle population (e.g., the 10th percentile particle size), D90 is the particle size in the upper 10% of the particle population (e.g., the 90th percentile particle size), D_{Avg} is the average particle size of the particle population, and Std. Dev. Is the standard deviation for the particle sizes of the particle population. All values are in micrometers (μm). D10 and D90 may also be defined as D^{SR}_{Min} and D^{SR}_{Max} of each particle group, respectively, wherein SR is 80% of a particle population, N. 98% of the particles in the larger particle group fell within a particle size range within about 20% of 18.6 μm (i.e., from 14.8 μm to 22.2 μm). 98% of the particles in the smaller particle group fell within a particle size range within about 20% of 18.6 μm (about 3.7 μm) away from 6.3 μm (i.e., from 2.8 μm to 10.3 μm). Therefore, the smaller particle group is also referred to as “the 7 μm” particles and the larger particle group is also referred to as “the 19 μm” particles. The median size ratio between the two particle groups was about 2.95 (18.6/6.3).

TABLE 1
Particle Size Characteristics of Lithium-
Based Layered Oxide Particle Groups

| | Smaller Particle Group | Larger Particle Group |
|---|---|---|
| | (7 μm sample) | (19 μm sample) |
| D_{Med} | 6.3 | 18.6 |
| D10 | 4.9 | 17.1 |
| D90 | 8.6 | 20.4 |
| D_{Avg} | 6.5 | 18.5 |
| Std. Dev. | 1.5 | 2.3 |

The two particle groups were then mixed together with varying mass ratios using a blender for 30 seconds. The tapped densities of the resulting mixtures were then measured with an automated tapping machine, which are graphed in FIG. 5.

As shown in FIG. 5, a local maximum tapped density occurred when a weight percentage of the smaller particle group was about 20 wt. % of the mixture (also referred to herein as “the 20 wt. % mixture”), resulting in a tapped density of 2.73 g·cm⁻³, compared to only 2.11 g·cm⁻³ for the smaller particle group (i.e., 100 wt. % of the 7 μm particles in FIG. 5) and 2.65 g cm⁻³ for the larger particle group (i.e., 0 wt. % of the 7 μm particles in FIG. 5).

The pressed density of each particle group and the 20 wt. % mixture were then measured. Samples were weighed and then pressed in a die to a specified applied pressure of 255 megapascals (MPa). The volume of the resulting pellets after pressing at the specified applied pressure was measured to determine sample density. The small particle group resulted in a pressed density of 2.89 g·cm³, the large particle group had a pressed density of 2.99 g·cm³, and the mixed particle group (20 wt. % smaller particles) had a pressed density of 3.18 g·cm⁻³.

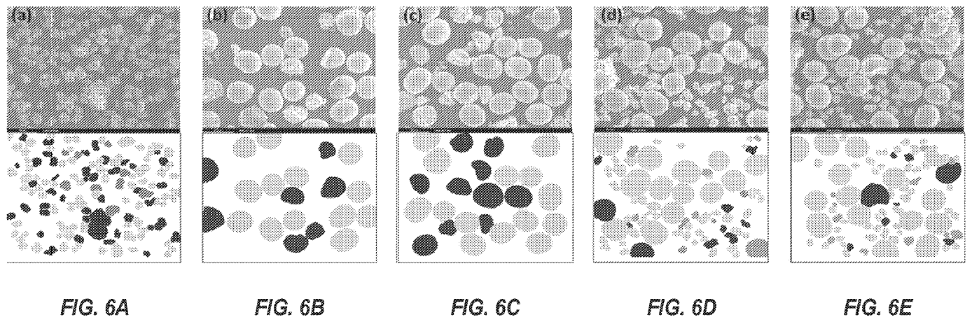

FIGS. 6A-6C show SEM images of each particle group to determine the extent of particle cracking as a result of pressing by the specified applied pressure.

In each of FIGS. 6A-6E, the bottom images show the SEM images after image processing to count cracked or broken particles within each particle group. FIG. 6A shows an SEM image and the processed image of the smallest 7 μm particle group alone. Two separate SEM images of the larger 19 μm particle group were captured and processed for the purpose of obtaining a large enough sample size of the larger particle group, which are shown in FIGS. 6B and 6C. Similarly, two separate SEM images of the 20 wt. % mixture were captured and processed to obtain a large enough sample size of the mixture, which are shown in FIGS. 6D and 6E.

In the processed images (i.e., the bottom row of images in FIGS. 6A-6E), clearly uncracked or unbroken particles are shown as light gray, clearly cracked or broken particles are shown as the black particles, and the particles shown as medium gray particles are considered “uncertain” (not determinable as clearly broken or clearly unbroken) due to lack of sufficient image resolution. As shown in TABLE 2 below, the extent of particle cracking was calculated by either “excluding” or “including” these “uncertain particles.” When they are being “excluded,” the uncertain particles were not used in the calculation determining the percent of particles that were cracked such that the percentage calculated was equal to the number of clearly cracked or broken particles divided by the total number of clearly cracked or broken particles and clearly uncracked or unbroken particles. When the uncertain particles were “included,” a range of cracked particle percentages were determined by assuming all of the uncertain particles in a particular population were uncracked for the lower end of the range (i.e., 31% for the 7 μm particles and 12% for the 19 μm particles) and that all of the uncertain particles in the population were cracked for the upper end of the range (i.e., 38% for the 7 μm particles and 26% for the 18 μm particles). The 20 wt. % mixture results in notably less particle cracking, minimizing unwanted degradation of the cathode particles.

TABLE 2
Percent of Particles Cracked After Application
of Specified Applied Pressure (255 MPa)

| | Excluding Uncertain | Including Uncertain |
|---|---|---|
| | Particles | Particles |
| 7 μm Particles Alone | 33% | 31-38% |
| 20 wt. % Mixture | 14% | 12-26% |
| 19 μm Particles Alone | 27% | 27% |

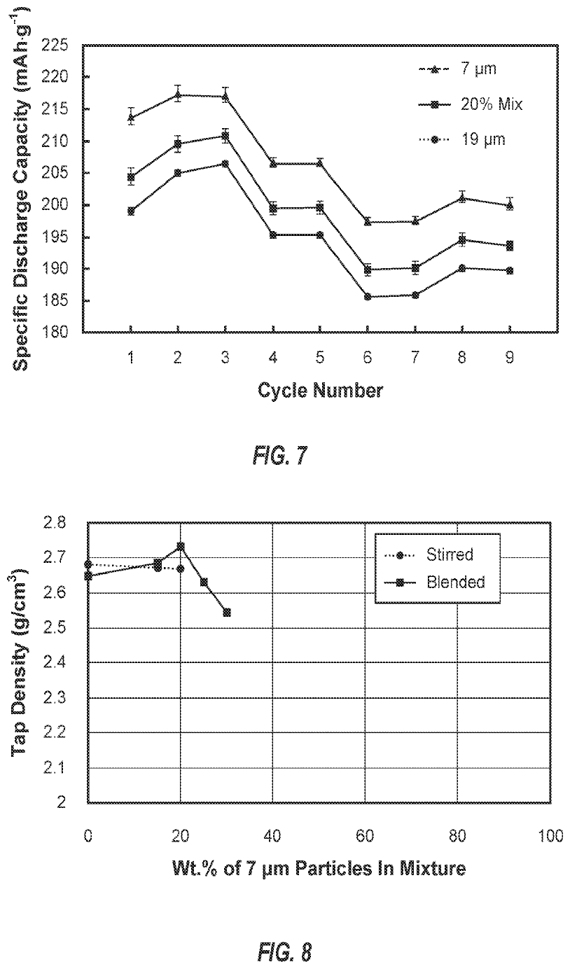

Each of the three samples (7 μm particles alone, 19 μm particles alone, and 20 wt. % mixture) were then included in a half cell first by mixing 90 wt. % of each particle population sample with 5 wt. % carbon black and 5 wt. % polyvinylidene fluoride (PVDF). N-Methylpyrrolidone (NMP) was then added to coat a thin film of the mixture onto an aluminum foil current collector with a loading of 2.5 mAh·cm⁻² of active cathode material on each current collector. The coated current collectors were then allowed to dry and were assembled into coin cells with a lithium metal anode, a polypropylene separator (Celgard, LLC, Charlotte, NC, USA), and a nonaqueous carbonate-based electrolyte comprising 1 molar LiPF₆ in a solvent mixture of ethylene carbonate and ethyl methyl carbonate (3:7 by weight) with an additive of vinylene carbonate (2% by weight). Electrochemical testing was performed on five (5) coin cells for each particle population sample. The cells were charged between 2.7-4.4 V at variable current rates vs. Li. The resulting specific capacity versus cycle number is shown in FIG. 7. As can be seen in FIG. 7, the 20 wt. % mixture has a specific capacity that is improved over the larger particle group alone, while also providing improved mechanical properties compared to the smaller particle group alone or the larger particle group alone, as described herein.

### Example 2

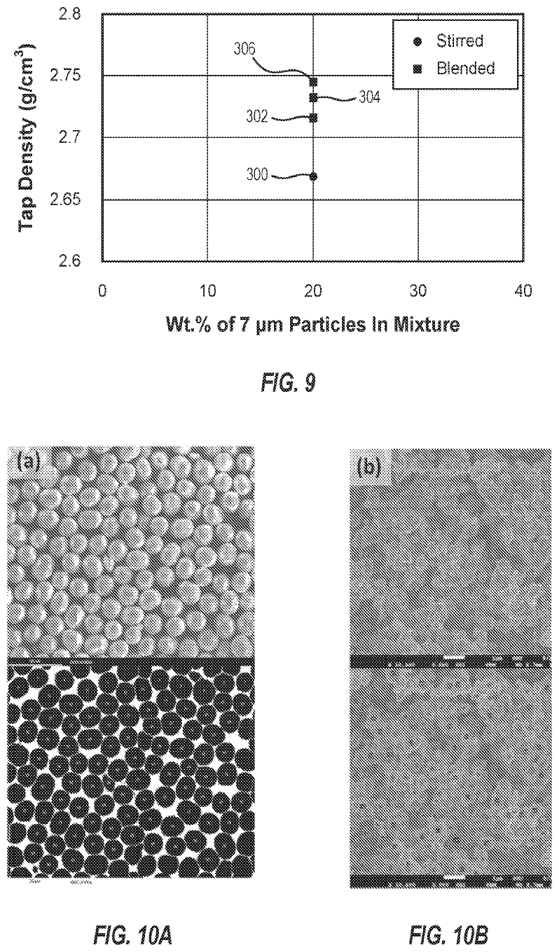

Different mixing methods were tested with the particle size groups of EXAMPLE 1. Mixtures having various weight percentages of the smaller particles were prepared by two different mixing techniques. In one technique, the two particle groups were mixed together by blending with a Magic Bullet Essential Personal blender (sold by nutribullet, LLC, Los Angeles, CA, USA) until the particles were visibly well dispersed (e.g., for about 3 seconds to about 120 seconds), and in the other technique the two particle groups were mixed together by stirring with a magnetic stir bar in a container while shaking the container until the particles were visibly well dispersed (e.g., for about 30 seconds). FIG. 8 shows the tapped densities that resulted when blending the two particle size groups together versus stirring. As can be seen in FIG. 8, mixing the particle groups by blending resulted in improved tapped densities at 15 wt. % and 20 wt. % of the smaller particle groups, and the inventors expect this improvement in tapped density for blending would carry over for other weight percent mixtures as well. FIG. 9 shows the tapped densities of several 20 wt. % mixture samples when mixed by stirring for about 30 seconds (data point 300), and when mixed by blending for several different amounts of blending time, specifically for 3 seconds, 30 seconds, and 120 seconds (data points 302, 304, and 306, respectively) As can be seen in FIG. 9, blending for longer periods of time increases the samples tapped density. Therefore, the inventors believe that mixing the large and small particle groups does not inherently increase density because both the mixing method and the particle group ratio influence the final tapped density of the mixture.

### Example 3

The large LiNi_{0.9}Mn_{0.05}Al_{0.05}O₂ particles (i.e., 19 μm group) from EXAMPLE 1 were mixed with a group of smaller particles comprising an olivine cathode material (LiFePO₄/C). The olivine cathode material was prepared with a solid-state synthesis method by grinding together a stoichiometric ratio of lithium carbonate (Li₂CO₃) and iron phosphate (FePO₄) and forming a slurry of the ground reactants in a solution of water with 1.3±0.5 wt. % glucose. The slurry was then dried and sintered in a furnace at 650±50° C. for 10±5 hours.

SEM images of the resulting particles are shown in FIGS. 10A and 10B, with the larger LiNi_{0.9}Mn_{0.05}Al_{0.05}O₂ particles being shown in FIG. 10A and the smaller olivine particles being shown in FIG. 10B. As with FIGS. 4A and 4B, the top image in each of FIGS. 10A and 10B is the SEM image itself and the bottom image in each of FIGS. 10A and 10B show the corresponding particle size distribution analysis.

The particle size characteristics of the groups of particles are shown in TABLE 3 below. D_{Med}, D10, D90, D_{Avg}, and Std. Dev. are the same as defined above for TABLE 1 for the particle groups of EXAMPLE 1. Also, similar to the particle groups in EXAMPLE 1, D10 and D90 may be defined as D^{SR}_{Min} and D^{SR}_{Max}, respectively, when SR is 80% of a particle population, N. 98% of the particles in the larger particle group (19 μm LiNi_{0.9}Mn_{0.05}Al_{0.05}O₂ particles) fell within a particle size range that is about 20% away from 18.6 μm (i.e., from 14.8 μm to 22.2 μm) and 100% of the smaller LiFePO₄ particles fell within a particle size range that is about 20% of 18.6 μm (about 3.7 μm) away from 0.5 μm (i.e., from 0 μm to 4.2 μm). The median size ratio (i.e., D_{Med} of the 19 μm LiNi_{0.9}Mn_{0.05}Al_{0.05}O₂ particles divided by D_{Med} of the smaller olivine particles) was 37.2.

TABLE 3
Particle Size Characteristics of Small Olivine and
Large Lithium-Based Layered Oxide Particle Groups

| | Olivine Particles | Li Layered Oxide Particles |
|---|---|---|
| | (Smaller Group) | (Larger Group) |
| D_{Med} | 0.5 | 18.6 |
| D10 | 0.3 | 17.1 |
| D90 | 0.8 | 20.4 |
| D_{Avg} | 0.5 | 18.5 |
| Std. Dev. | 0.2 | 2.3 |

A bimodal mixture comprising 20 wt. % of the smaller LiFePO₄ particles and 80 wt. % of the 19 μm LiNi_{0.9}Mn_{0.05}Al_{0.05}O₂ particles was formed via blender for 60 seconds. The tapped densities of the mixed and unmixed particle groups were then measured with an automated tapping machine. The smaller LiFePO₄ particles alone resulted in a tapped density of 1.11 g·cm⁻³, compared to 2.65 g·cm⁻³ for the 19 μm LiNi_{0.9}Mn_{0.05}Al_{0.05}O₂ particles alone, and 2.58 g·cm⁻³ for the bimodal mixture. The inventors hypothesize that a higher tapped density may be achieved by decreasing the amount of the smaller LiFePO₄ particles to about 10 wt. % due to the density of LifePO₄ being about half that of LiNi_{0.9}Mn_{0.05}Al_{0.05}O₂.

The pressed density of the smaller LiFePO₄ particles, the larger LiNi_{0.9}Mn_{0.05}Al_{0.05}O₂ particles, and the bimodal mixture were then measured using the same method as described above in EXAMPLE 1. Samples were weighed then pressed in a die to a specified applied pressure of 255 MPa. The volume of the resulting pellets after pressing at the specified applied pressure was measured to determine sample density. The smaller LiFePO₄ particles alone resulted in a pressed density of 2.32 g·cm⁻³, compared to a pressed density of 2.99 g·cm⁻³ for the 19 μm LiNi_{0.9}Mn_{0.05}Al_{0.05}O₂ particles, and the highest pressed density of 3.18 g·cm⁻³ for the bimodal mixture.

### Example 4

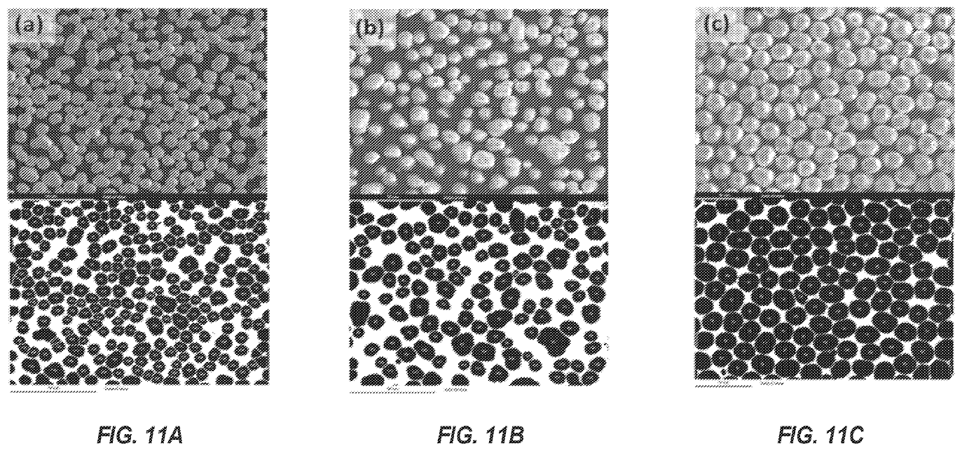

A multimodal mixture comprising multiple particle sizes of LiNi_{0.85}Mn_{0.07}Co_{0.03}Al_{0.05}O₂ and LiNi_{0.9}Mn_{0.05}Al_{0.05}O₂ lithium-based layered oxide cathode active materials was formed by blending three size groups of particles for 60 seconds. The smallest sized particle group comprised LiNi_{0.85}Mn_{0.07} Co_{0.03}Al_{0.05}O₂, which was synthesized according to a method similar to the method described above for the particle groups of EXAMPLE 1, but including a stoichiometric amount of cobalt sulfate (CoSO₄) in the mixed-metal ion aqueous solution to form a Ni_{0.85}Mn_{0.07}Co_{0.03}Al_{0.05}(OH)₂ precursor before calcination. The intermediate sized particle group and the largest sized particle group comprised LiNi_{0.9}Mn_{0.05}Al_{0.05}O₂ particles synthesized according to the method described above for the particle groups of EXAMPLE 1. SEM images of the three particle size groups are shown in FIGS. 11A-11C. As with FIGS. 4A, 4B, 10A, and 10B, the top image in each of FIGS. 11A-11C is the SEM image itself and the bottom image in each of FIGS. 11A-11C show the corresponding particle size analysis. FIG. 11A corresponds to the smallest sized LiNi_{0.85}Mn_{0.07}Co_{0.03}Al_{0.05}O₂ particles, FIG. 11B corresponds to the intermediate sized LiNi_{0.9}Mn_{0.05}Al_{0.05}O₂ particles, and FIG. 11C corresponds to the largest sized LiNi_{0.9}Mn_{0.05}Al_{0.05}O₂ particles.

The particle size characteristics of the three groups of particles are shown in TABLE 4 below. D_{Med}, D10, D90, D_{Avg}, and Std. Dev. are the same as defined above for TABLE 1 for the particle groups of EXAMPLE 1. Also, similar to the particle groups in EXAMPLES 1 and 3, D10 and D90 may be defined as D^{SR}_{Min} and D^{SR}_{Max}, respectively, when SR is 80% of a particle population, N.

TABLE 4
Particle Size Characteristics of Multimodal
Lithium-Based Layered Oxide Particle Groups

| | 8 μm Particles | 10 μm Particles | 19 μm Particles |
|---|---|---|---|
| D_{Med} | 7.6 | 9.3 | 18.6 |
| D10 | 6.3 | 7.4 | 17.1 |
| D90 | 9.5 | 12.3 | 20.4 |
| D_{Avg} | 7.8 | 9.6 | 18.5 |
| Std. Dev. | 1.2 | 1.9 | 2.3 |

The multimodal mixture comprises 20 wt. % of the smallest sized LiNi_{0.85}Mn_{0.07}Co_{0.03}Al_{0.05}O₂ particles having a median particle size of 7.6 μm (also referred to as the “8 μm particles”), 10 wt. % of the intermediate sized LiNi_{0.9}Mn_{0.05}Al_{0.05}O₂ particles having a median particle size of 9.3 μm (also referred to as the “10 μm particles”), and 70 wt. % of the largest sized LiNi_{0.9}Mn_{0.05}Al_{0.05}O₂ particles having a median particle size of 18.6 μm (also referred to as the “19 μm particles”). 98% of particles in the largest size 19 μm particle group fell within 20% of 18.6 μm (i.e., from 14.8 μm to 22.2 μm). 94% of particles in the intermediate sized 10 μm particle group fell within a particle size range that is about 20% of the largest median particle size (i.e., 3.7 μm, or 20% of 18.6 μm) away from 9.3 μm (i.e., from 5.5 μm to 13.0 μm). And 99% of particles in the smallest size 8 μm particle group fell within a particle size range that is about 20% of the largest median particle size (i.e., 3.7 μm, or 20% of 18.6 μm) away from 7.6 μm (i.e., 3.8 μm to 11.3 μm). The median size ratio of the largest sized particle group relative to the smallest sized particle group is 2.4.

The tapped density and pressed density of the samples were then measured according to the methods described in EXAMPLE 1. The smallest 8 μm particle group resulted in a tapped density of 2.32 g·cm⁻³, the intermediate 10 μm particle group resulted in a tapped density of 2.57 g·cm⁻³, the largest 19 μm particle group resulted in a tapped density of 2.65 g·cm⁻³, and the multimodal mixture resulted in a tapped density of 2.60 g·cm⁻³. The pressed density of the 19 μm particle group was 2.99 g·cm⁻³, while the multimodal mixture resulted in a higher pressed density of 3.13 g·cm⁻³.

### Example 5

The 8 μm and 19 μm particle groups from EXAMPLE 4 were blended for 60 seconds in a 20:80 wt. % ratio, respectively, to form a bimodal mixture. The tapped density and pressed density of the samples were then measured according to the methods described in EXAMPLE 1. The 8 μm particle group had a tapped density of 2.32 g·cm⁻³, the 19 μm particle group had a tapped density of 2.65 g·cm⁻³, and the bimodal mixture had a tapped density of 2.65 g·cm⁻³. The 19 μm particle group had a pressed density of 2.99 g·cm⁻³, while the bimodal mixture had a higher pressed density of 3.05 g·cm⁻³.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### Illustrative Aspects

As used below, any reference to a series of aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is a particulate composition comprising: a mixture of a plurality of particles, wherein the mixture comprises: a first particle group comprising a first portion of the particles, wherein the particles of the first particle group comprise one or more first electrode active materials and have a first median particle size; and a second particle group comprising a second portion of the particles, wherein the particles of the second particle group comprise one or more second electrode active materials and have a second median particle size, wherein a ratio of the first median particle size to the second median particle size is at least 2.75.

Aspect 2 is a particulate composition comprising: a mixture of a plurality of particles each comprising one or more electrode active materials, wherein the mixture comprises: a first particle group comprising a first portion of the particles, wherein the first particle group has a first median particle size, wherein at least about 50%, by population, of the particles in the first particle group are within a first specified particle size range that is about 20% of the first median particle size away from the first median particle size; and a second particle group comprising a second portion of the particles, wherein the second particle group has a second median particle size that is smaller than the first median particle size, wherein at least about 50%, by population, of the particles in the second particle group are within a second specified particle size range that is about 20% of the first median particle size away from the second median particle size, wherein at least one of the first particle group and the second particle group comprises a lithium-based metal layered oxide electrode active material, and wherein a ratio of the first median particle size to the second median particle size is at least 1.5.

Aspect 3 is particulate composition of any previous or subsequent aspect, wherein one or more first electrode active materials are different from one or more second electrode active materials.

Aspect 4 is particulate composition of any previous or subsequent aspect, wherein one or more first electrode active materials comprise a lithium-based metal layered oxide active material.

Aspect 5 is particulate composition of any previous or subsequent aspect, wherein one or more second electrode active materials comprise at least one of: an olivine phosphate or a spinel oxide cathode active material.

Aspect 6 is particulate composition of any previous or subsequent aspect, wherein one or more second active materials do not include a lithium-based metal layered oxide active material.

Aspect 7 is particulate composition of any previous or subsequent aspect, wherein one or more second electrode active materials comprise one or more lithium-based metal layered oxide active materials.

Aspect 8 is particulate composition of any previous or subsequent aspect, wherein the ratio of the first median particle size to the second median particle size is at least 3.

Aspect 9 is particulate composition of any previous or subsequent aspect, wherein the ratio of the first median particle size to the second median particle size is at least 4.

Aspect 10 is particulate composition of any previous or subsequent aspect, wherein the ratio of the first median particle size to the second median particle size is at least 5.

Aspect 11 is particulate composition of any previous or subsequent aspect, wherein the ratio of the first median particle size to the second median particle size is at least 6.

Aspect 12 is particulate composition of any previous or subsequent aspect, wherein the ratio of the first median particle size to the second median particle size is at least 7.

Aspect 13 is particulate composition of any previous or subsequent aspect, wherein the ratio of the first median particle size to the second median particle size is at least 8.

Aspect 14 is particulate composition of any previous or subsequent aspect, wherein the mixture is free or substantially free of cobalt.

Aspect 15 is particulate composition of any previous or subsequent aspect, wherein the first particle group exhibits a first extent of particle cracking after application of a specified applied pressure of at least 200 MPa, the second particle group exhibits a second extent of particle cracking after application of the specified applied pressure, and the mixture exhibits a third extent of particle cracking after application of the specified applied pressure, wherein the third extent of particle cracking of the mixture is lower than either the first extent of particulate cracking of the first particulate group or the second extent of particle cracking of the second particulate group.

Aspect 16 is particulate composition of any previous or subsequent aspect, wherein the third extent of particle cracking of the mixture is lower than both the first extent of particle cracking of the first particulate group and the second extent of particle cracking of the second particulate group.

Aspect 17 is particulate composition of any previous or subsequent aspect, wherein the mixture has a tapped density of at least about 2.3 grams per cubic centimeter.

Aspect 18 is particulate composition of any previous or subsequent aspect, wherein the mixture has a tapped density of at least about 2.6 grams per cubic centimeter.

Aspect 19 is particulate composition of any previous or subsequent aspect, wherein the first particle group and the second particle group comprise at least about 50%, by weight, of the plurality of particles in the mixture.

Aspect 20 is particulate composition of any previous or subsequent aspect, wherein the first particle group and the second particle group comprises at least about 75%, by weight, of the plurality of particles in the mixture.

Aspect 21 is particulate composition of any previous or subsequent aspect, wherein the first particle group and the second particle group comprises at least about 90%, by weight, of the plurality of particles in the mixture.

Aspect 22 is particulate composition of any previous or subsequent aspect, wherein the first particle group and the second particle group comprises at least about 95%, by weight, of the plurality of particles in the mixture.

Aspect 23 is particulate composition of any previous or subsequent aspect, wherein the first particle group and the second particle group comprise at least about 99%, by weight, of the plurality of particles in the mixture.

Aspect 24 is particulate composition of any previous or subsequent aspect, wherein the mixture is formed by combining the first particle group and the second particle group by at least one of: blending, shaking, pressing, stirring, or grinding.

Aspect 25 is particulate composition of any previous or subsequent aspect, wherein the first particle group has a first gravimetric energy density and the second particle group has a second gravimetric energy density, wherein the first gravimetric energy density is higher than the second gravimetric energy density.

Aspect 26 is particulate composition of any previous or subsequent aspect, wherein the first particle group has a first gravimetric energy density and the second particle group has a second gravimetric energy density, wherein the second gravimetric energy density is higher than the first gravimetric energy density.

Aspect 27 is particulate composition of any previous or subsequent aspect, wherein the mixture has a third gravimetric energy density that is greater than both the first gravimetric energy density and the second gravimetric energy density.

Aspect 28 is particulate composition of any previous or subsequent aspect, wherein the third gravimetric energy density is from about 0.01% to about 100% higher than the first gravimetric energy density.

Aspect 29 is particulate composition of any previous or subsequent aspect, wherein the third gravimetric energy density is from about 0.01% to about 100% higher than the second gravimetric energy density.

Aspect 30 is particulate composition of any previous or subsequent aspect, wherein the first particle group has a first volumetric energy density and the second particle group has a second volumetric energy density, wherein the first volumetric energy density is higher than the second volumetric energy density.

Aspect 31 is particulate composition of any previous or subsequent aspect, wherein the first particle group has a first volumetric energy density and the second particle group has a second volumetric energy density, wherein the second volumetric energy density is higher than the first volumetric energy density.

Aspect 32 is particulate composition of any previous or subsequent aspect, wherein the mixture has a third volumetric energy density that is greater than both the first volumetric energy density and the second volumetric energy density.

Aspect 33 is particulate composition of any previous or subsequent aspect, wherein the third volumetric energy density is from about 0.01% to about 100% higher than the first volumetric energy density.

Aspect 34 is particulate composition of any previous or subsequent aspect, wherein the third volumetric energy density is from about 0.01% to about 100% higher than the second volumetric energy density.

Aspect 35 is particulate composition of any previous or subsequent aspect, wherein the first particle group has a first first-cycle coulombic efficiency and the second particle group has a second first-cycle coulombic efficiency, wherein the first first-cycle coulombic efficiency is higher than the second first-cycle coulombic efficiency.

Aspect 36 is particulate composition of any previous or subsequent aspect, wherein the first particle group has a first first-cycle coulombic efficiency and the second particle group has a second first-cycle coulombic efficiency, wherein the second first-cycle coulombic efficiency is higher than the first first-cycle coulombic efficiency.

Aspect 37 is particulate composition of any previous or subsequent aspect, wherein the mixture has a third first-cycle coulombic efficiency that is greater than both the first first-cycle coulombic efficiency and the second first-cycle coulombic efficiency.

Aspect 38 is particulate composition of any previous or subsequent aspect, wherein the third first-cycle coulombic efficiency is from about 0.01% to about 100% higher than the first first-cycle coulombic efficiency.

Aspect 39 is particulate composition of any previous or subsequent aspect, wherein the third first-cycle coulombic efficiency is from about 0.01% to about 100% higher than the second first-cycle coulombic efficiency.

Aspect 40 is particulate composition of any previous or subsequent aspect, wherein the first particle group has a first rate capability and the second particle group has a second rate capability, wherein the first rate capability is higher than the second rate capability.

Aspect 41 is particulate composition of any previous or subsequent aspect, wherein the first particle group has a first rate capability and the second particle group has a second rate capability, wherein the second rate capability is higher than the first rate capability.

Aspect 42 is particulate composition of any previous or subsequent aspect, wherein the mixture has a third rate capability that is greater than both the first rate capability and the second rate capability.

Aspect 43 is particulate composition of any previous or subsequent aspect, wherein the third rate capability is from about 0.01% to about 100% higher than the first rate capability.

Aspect 44 is particulate composition of any previous or subsequent aspect, wherein the third rate capability is from about 0.001% to about 100% higher than the second rate capability.

Aspect 45 is particulate composition of any previous or subsequent aspect, wherein the first particle group has a first thermal stability and the second particle group has a second thermal stability, wherein the first thermal stability is higher than the second thermal stability.

Aspect 46 is particulate composition of any previous or subsequent aspect, wherein the first particle group has a first thermal stability and the second particle group has a second thermal stability, wherein the second thermal stability is higher than the first thermal stability.

Aspect 47 is particulate composition of any previous or subsequent aspect, wherein the mixture has a third thermal stability that is greater than both the first thermal stability and the second thermal stability.

Aspect 48 is particulate composition of any previous or subsequent aspect, wherein the third thermal stability is from about 0.01% to about 100% higher than the first thermal stability.

Aspect 49 is particulate composition of any previous or subsequent aspect, wherein the third thermal stability is from about 0.01% to about 100% higher than the second thermal stability.

Aspect 50 is particulate composition of any previous or subsequent aspect, wherein the first particle group has a first cycle life, the second particle group has a second cycle life, and the mixture has a third cycle life, wherein the third cycle life is greater than both the first cycle life and the second cycle life.

Aspect 51 is particulate composition of any previous or subsequent aspect, wherein the third cycle life is from about 0.01% to about 100% higher than the first cycle life.

Aspect 52 is particulate composition of any previous or subsequent aspect, wherein the third cycle life is from about 0.01% to about 100% higher than the second cycle life.

Aspect 53 is particulate composition of any previous or subsequent aspect, wherein the first particle group can withstand a first compressive force before 10% of the first portion of the particles exhibits cracking, the second particle group can withstand a second compressive force before 10% of the second portion of the particles exhibits cracking, and the mixture can withstand a third compressive force before 10% of the plurality of particles exhibits cracking, wherein the third compressive force is greater than both the first compressive force and the second compressive force.

Aspect 54 is particulate composition of any previous or subsequent aspect, wherein the first particle group exhibits or is characterized by a dQ·dV⁻¹ curve at a second charge-discharge formation cycle for a current rate of C/10 having a minimum during discharge at a voltage of from about 4.19 V to about 4.3 V vs. Li⁺/Li.

Aspect 55 is particulate composition of any previous or subsequent aspect, wherein the second particle group exhibits or is characterized by a dQ·dV⁻¹ curve at a second charge-discharge formation cycle for a current rate of C/10 having a minimum during discharge at a voltage of from about 4.19 V to about 4.3 V vs. Li⁺/Li.

Aspect 56 is particulate composition of any previous or subsequent aspect, wherein the mixture exhibits or is characterized by a dQ·dV⁻¹ curve at a second charge-discharge formation cycle for a current rate of C/10 having a minimum during discharge at a voltage of from about 4.19 V to about 4.3 V vs. Li⁺/Li.

Aspect 57 is particulate composition of any previous or subsequent aspect, wherein the first particle group comprises secondary particles each formed from a plurality of primary particles, wherein the secondary particles have a spherical morphology.

Aspect 58 is particulate composition of any previous or subsequent aspect, wherein a diameter size ratio of the primary particles relative to the secondary particles is from about 0.0005 to about 1.

Aspect 59 is particulate composition of any previous or subsequent aspect, wherein the second particle group comprises secondary particles each formed from a plurality of primary particles, wherein the secondary particles have a spherical morphology.

Aspect 60 is particulate composition of any previous or subsequent aspect, wherein a diameter size ratio of the primary particles relative to the secondary particles is from about 0.0005 to about 1.

Aspect 61 is particulate composition of any previous or subsequent aspect, wherein the particles of the first particle group are coated with a first metal oxide or a first metal phosphate.

Aspect 62 is particulate composition of any previous or subsequent aspect, wherein the first metal oxide comprises at least one of alumina, magnesium oxide, zirconium oxide, zinc oxide, tungsten oxide, and boron oxide, and the first metal phosphate comprises at least one of lithium phosphate, and aluminum phosphate.

Aspect 63 is particulate composition of any previous or subsequent aspect, wherein the particles of the second particle group are coated with a second metal oxide or a second metal phosphate.

Aspect 64 is particulate composition of any previous or subsequent aspect, wherein the second metal oxide comprises at least one of alumina, magnesium oxide, zirconium oxide zinc oxide, tungsten oxide, and boron oxide, and the second metal phosphate comprises at least one of lithium phosphate, and aluminum phosphate.

Aspect 65 is particulate composition of any previous or subsequent aspect, wherein the ratio of the first median particle size to the second median particle size is at least 2.

Aspect 66 is particulate composition of any previous or subsequent aspect, wherein the ratio of the first median particle size to the second median particle size is at least 10.

Aspect 67 is particulate composition of any previous or subsequent aspect, wherein the ratio of the first median particle size to the second median particle size is at least 30.

Aspect 68 is particulate composition of any previous or subsequent aspect, wherein the particle sizes of at least about 70% of the particles in the first particle group are within the first specified particle size range.

Aspect 69 is particulate composition of any previous or subsequent aspect, wherein the particle sizes of at least about 80% of the particles in the first particle group are within the first specified particle size range.

Aspect 70 is particulate composition of any previous or subsequent aspect, wherein the particle sizes of at least about 90% of the particles in the first particle group are within the first specified particle size range.

Aspect 71 is particulate composition of any previous or subsequent aspect, wherein the particle sizes of at least about 95% of the particles in the first particle group are within the first specified particle size range.

Aspect 72 is particulate composition of any previous or subsequent aspect, wherein the particle sizes of at least about 70% of the particles in the second particle group are within the second specified particle size range.

Aspect 73 is particulate composition of any previous or subsequent aspect, wherein the particle sizes of at least about 80% of the particles in the second particle group are within the second specified particle size range.

Aspect 74 is particulate composition of any previous or subsequent aspect, wherein the particle sizes of at least about 90% of the particles in the second particle group are within the second specified particle size range.

Aspect 75 is particulate composition of any previous or subsequent aspect, wherein the particle sizes of at least about 95% of the particles in the second particle group are within the second specified particle size range.

Aspect 76 is particulate composition of any previous or subsequent aspect, wherein the first specified particle size range is about 15% of the first median particle size away from the first median particle size.

Aspect 77 is particulate composition of any previous or subsequent aspect, wherein the first specified particle size range is about 10% of the first median particle size away from the first median particle size.

Aspect 78 is particulate composition of any previous or subsequent aspect, wherein the first specified particle size range is about 7.5% of the first median particle size away from the first median particle size.

Aspect 79 is particulate composition of any previous or subsequent aspect, wherein the first specified particle size range is about 5% of the first median particle size away the first median particle size.

Aspect 80 is particulate composition of any previous or subsequent aspect, wherein the second specified particle size range is about 15% of the first median particle size away from the second median particle size.

Aspect 81 is particulate composition of any previous or subsequent aspect, wherein the second specified particle size range is about 10% of the first median particle size away from the second median particle size.

Aspect 82 is particulate composition of any previous or subsequent aspect, wherein the second specified particle size range is about 7.5% of the first median particle size away from the second median particle size.

Aspect 83 is particulate composition of any previous or subsequent aspect, wherein the second specified particle size range is about 5% of the first median particle size away from the second median particle size.

Aspect 84 is particulate composition of any previous or subsequent aspect, wherein the lithium-based metal oxide active material of the first particle group has the formula: LiₐNi_{(1-b-c)}CO_{b}M_{c}O_{d}, wherein M is at least one of: one or more transition metals, one or more post-transition metals, one or more rare earth metals, one or more alkaline earth metals, one or more alkali metals, one or more metalloids, and one or more non-metals.

Aspect 85 is particulate composition of any previous or subsequent aspect, wherein at least a portion of the second particle group comprises an active material that is different from the lithium-based metal oxide active material of the first particle group having the formula LiₐNi_{(1-b-c)}Co_{b}M_{c}O_{d}.

Aspect 86 is particulate composition of any previous or subsequent aspect, wherein the portion of the second particle group comprises at least one of: an olivine phosphate or a spinel oxide cathode active material.

Aspect 87 is particulate composition of any previous or subsequent aspect, wherein one or more electrode active materials of the second particle group comprises a lithium-based metal layered oxide active material.

Aspect 88 is particulate composition of any previous or subsequent aspect, wherein the lithium-based metal oxide active material of the second particle group has the formula: LiₐNi_{(1-b-c)}Co_{b}M_{c}O_{d}, wherein M is at least one of: one or more transition metals, one or more post-transition metals, one or more rare earth metals, one or more alkaline earth metals, one or more alkali metals, one or more metalloids, and one or more non-metals.

Aspect 89 is particulate composition of any previous or subsequent aspect, wherein at least a portion of the first particle group comprises an active material that is different from the lithium-based metal oxide active material of the second particle group having the formula LiₐNi_{(1-b-c)}Co_{b}M_{c}O_{d}.

Aspect 90 is particulate composition of any previous or subsequent aspect, wherein the portion of the first particle group comprises at least one of: an olivine phosphate or a spinel oxide cathode active material.

Aspect 91 is an electrode structure comprising: an electrode body coated with an electrode coating, the electrode coating comprising; the particulate composition of any previous or subsequent aspect; a binding agent; and a conductive additive.

Aspect 92 is an electrode structure of any previous or subsequent aspect, wherein the binding agent is less than about 10 wt. % of the coating composition.

Aspect 93 is an electrode structure of any previous or subsequent aspect, wherein the electrode coating has an active mass loading of from about 2 milligrams per square centimeter to about 30 milligrams per square centimeter.

Aspect 94 is an electrode structure of any previous or subsequent aspect, wherein the electrode coating has a packing density of from about 2.7 grams per cubic centimeter to about 3.9 grams per cubic centimeter.

Aspect 95 is an electrode structure of any previous or subsequent aspect, wherein the electrode coating has a packing density of from about 3.2 grams per cubic centimeter to about 3.9 grams per cubic centimeter.

Aspect 96 is an electrode structure of any previous or subsequent aspect, wherein the electrode coating has a packing density of from about 3.7 grams per cubic centimeter to about 3.9 grams per cubic centimeter.

Aspect 97 is a method comprising the steps of: coating an electrode body with a coating composition, the coating composition comprising the particulate composition of any previous or subsequent aspect, a binding agent, a conductive additive, and a solvent; and evaporating the solvent from the coating composition to leave an electrode coating on the electrode body, the electrode coating comprising the particulate composition, the binding agent, and the conductive additive.

Aspect 98 is a method of any previous or subsequent aspect, wherein the binding agent is less than about 10 wt. % of the coating composition.

Aspect 99 is a method of any previous or subsequent aspect, wherein the electrode coating has an active mass loading of from about 2 milligrams per square centimeter to about 30 milligrams per square centimeter.

Aspect 100 is a method of any previous or subsequent aspect, wherein the electrode coating has a packing density of from about 2.7 grams per cubic centimeter to about 3.9 grams per cubic centimeter.

Aspect 101 is a method of any previous or subsequent aspect, wherein the electrode coating has a packing density of from about 3.2 grams per cubic centimeter to about 3.9 grams per cubic centimeter.

Aspect 102 is a method of any previous or subsequent aspect, wherein the electrode coating has a packing density of from about 3.7 grams per cubic centimeter to about 3.9 grams per cubic centimeter.

Aspect 103 is an electrochemical cell comprising: a cathode comprising the particulate composition of any previous or subsequent aspect; an anode; a separator between the anode and the cathode; and an electrolyte.

Aspect 104 is an electrochemical cell of any previous or subsequent aspect, wherein the cathode comprises a cathode body coated with an electrode coating, the electrode coating comprising the particulate composition, a binding agent, and a conductive additive.

Aspect 105 is an electrochemical cell of any previous or subsequent aspect, wherein the electrode coating has an active mass loading of from about 2 milligrams per square centimeter to about 30 milligrams per square centimeter.

Aspect 106 is an electrochemical cell of any previous or subsequent aspect, wherein the electrode coating has a packing density of from about 2.7 grams per cubic centimeter to about 3.9 grams per cubic centimeter.

Aspect 107 is an electrochemical cell of any previous or subsequent aspect, wherein the electrode coating has a packing density of from about 3.2 grams per cubic centimeter to about 3.9 grams per cubic centimeter.

Aspect 108 is an electrochemical cell of any previous or subsequent aspect, wherein the electrode coating has a packing density of from about 3.7 grams per cubic centimeter to about 3.9 grams per cubic centimeter.

Aspect 109 is an electrochemical cell of any previous or subsequent aspect, wherein the electrochemical cell is capable of achieving a cycle life, wherein the cycle life is longer than a comparative cycle life of a comparative electrochemical cell, wherein the comparative electrochemical cell comprises: a comparative cathode comprising only the particles of the first particle group or only the particles of the second particle group, but not both; a comparative anode that is the same as the anode of the electrochemical cell; a comparative separator that is the same as the separator of the electrochemical cell; and a comparative electrolyte that is the same as the electrolyte of the electrochemical cell.

Aspect 110 is an electrochemical cell of any previous or subsequent aspect, wherein a volumetric energy density of the cathode of the electrochemical cell is higher than a comparative volumetric energy density for a comparative cathode of a comparative electrochemical cell, wherein the comparative cathode of the comparative electrochemical cell comprises only the particles of the first particle group or only the particles of the second particle group, but not both, and wherein the comparative electrochemical cell further comprises a comparative anode that is the same as the anode of the electrochemical cell, a comparative separator that is the same as the separator of the electrochemical cell, and a comparative electrolyte that is the same as the electrolyte of the electrochemical cell.

Aspect 111 is an electrochemical cell of any previous or subsequent aspect, wherein a gravimetric energy density of the cathode of the electrochemical cell is higher than a comparative gravimetric energy density for a comparative cathode of a comparative electrochemical cell, wherein the comparative cathode of the comparative electrochemical cell comprises only the particles of the first particle group or only the particles of the second particle group, but not both, and wherein the comparative electrochemical cell further a comparative anode that is the same as the anode of the electrochemical cell, a comparative separator that is the same as the separator of the electrochemical cell, and a comparative electrolyte that is the same as the electrolyte of the electrochemical cell.

Aspect 112 is an electrochemical cell of any previous or subsequent aspect, wherein a high-rate capability of the electrochemical cell is higher than a comparative high-rate capability for a comparative electrochemical cell, wherein the comparative electrochemical cell comprises: a comparative cathode comprising only the particles of the first particle group or only the particles of the second particle group, but not both; a comparative anode that is the same as the anode of the electrochemical cell; a comparative separator that is the same as the separator of the electrochemical cell; and a comparative electrolyte that is the same as the electrolyte of the electrochemical cell.

1-163. (canceled)

164. A particulate composition comprising:
a mixture of a plurality of particles, wherein the mixture comprises:
a first particle group comprising a first portion of the particles, wherein the particles of the first particle group comprise one or more first electrode active materials and have a first median particle size; and
a second particle group comprising a second portion of the particles, wherein the particles of the second particle group comprise one or more second electrode active materials and have a second median particle size,
wherein a ratio of the first median particle size to the second median particle size is at least 2.75.

165. The particulate composition of claim 164, wherein one or more first electrode active materials comprise a lithium-based metal layered oxide active material.

166. The particulate composition of claim 164, wherein one or more second electrode active materials comprise at least one of: an olivine phosphate or a spinel oxide cathode active material.

167. The particulate composition of claim 164, wherein the mixture is free or substantially free of cobalt.

168. The particulate composition of claim 164, wherein the first particle group exhibits a first extent of particle cracking after application of a specified applied pressure of at least 200 MPa, the second particle group exhibits a second extent of particle cracking after application of the specified applied pressure, and the mixture exhibits a third extent of particle cracking after application of the specified applied pressure, wherein the third extent of particle cracking of the mixture is lower than both the first extent of particle cracking of the first particulate group and the second extent of particle cracking of the second particulate group.

169. The particulate composition of claim 164, characterized by a density of from about 3 g/cm³ to about 4.4 g/cm³ after an applied pressure of at least 6 is missing parent: 200 MPa.

170. The particulate composition of claim 164, wherein the mixture is formed by combining the first particle group and the second particle group by at least one of: blending, shaking, pressing, stirring, or grinding.

171. The particulate composition of claim 164, wherein the first particle group has a first gravimetric energy density and the second particle group has a second gravimetric energy density, wherein the mixture has a third gravimetric energy density that is greater than both the first gravimetric energy density and the second gravimetric energy density.

172. The particulate composition of claim 164, wherein the first particle group has a first rate capability and the second particle group has a second rate capability, wherein the mixture has a third rate capability that is greater than both the first rate capability and the second rate capability.

173. The particulate composition of claim 164, wherein the first particle group comprises secondary particles each formed from a plurality of primary particles, wherein the secondary particles have a spherical morphology.

174. A particulate composition comprising:
a mixture of a plurality of particles each comprising one or more electrode active materials, wherein the mixture comprises:
a first particle group comprising a first portion of the particles, wherein the first particle group has a first median particle size, wherein at least about 50%, by population, of the particles in the first particle group are within a first specified particle size range that is about 20% of the first median particle size away from the first median particle size; and
a second particle group comprising a second portion of the particles, wherein the second particle group has a second median particle size that is smaller than the first median particle size, wherein at least about 50%, by population, of the particles in the second particle group are within a second specified particle size range that is about 20% of the first median particle size away from the second median particle size,
wherein at least one of the first particle group and the second particle group comprises a lithium-based metal layered oxide electrode active material, and wherein a ratio of the first median particle size to the second median particle size is at least 1.5.

175. The particulate composition of claim 174, wherein the mixture is formed by combining the first particle group and the second particle group by at least one of:
blending, shaking, pressing, stirring, or grinding.

176. The particulate composition of claim 174, wherein the lithium-based metal oxide active material of the first particle group has the formula: 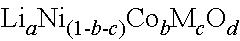
wherein M is at least one of: one or more transition metals, one or more post-transition metals, one or more rare earth metals, one or more alkaline earth metals, one or more alkali metals, one or more metalloids, and one or more non-metals.

177. The particulate composition of claim 176, wherein the portion of the second particle group comprises at least one of: an olivine phosphate or a spinel oxide cathode active material.

178. The particulate composition of claim 174, wherein the lithium-based metal oxide active material of the second particle group has the formula: 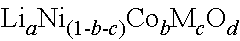
wherein M is at least one of: one or more transition metals, one or more post-transition metals, one or more rare earth metals, one or more alkaline earth metals, one or more alkali metals, one or more metalloids, and one or more non-metals.

179. The particulate composition of claim 178, wherein the portion of the first particle group comprises at least one of: an olivine phosphate or a spinel oxide cathode active material.

180. The particulate composition of claim 174, wherein the mixture is free or substantially free of cobalt.

181. The particulate composition of claim 174, wherein the first particle group has a first gravimetric energy density and the second particle group has a second gravimetric energy density, wherein the mixture has a third gravimetric energy density that is greater than both the first gravimetric energy density and the second gravimetric energy density.

182. The particulate composition of claim 174, wherein the first particle group has a first rate capability and the second particle group has a second rate capability, wherein the mixture has a third rate capability that is greater than both the first rate capability and the second rate capability.

183. The particulate composition of claim 174, wherein the first particle group exhibits a first extent of particle cracking after application of a specified applied pressure of at least 200 MPa, the second particle group exhibits a second extent of particle cracking after application of the specified applied pressure, and the mixture exhibits a third extent of particle cracking after application of the specified applied pressure, wherein the third extent of particle cracking of the mixture is lower than both the first extent of particle cracking of the first particulate group and the second extent of particle cracking of the second particulate group.

184. The particulate composition of claim 174, characterized by a density of from about 3 g/cm³ to about 4.4 g/cm³ after an applied pressure of at least 200 MPa.

185. The particulate composition of claim 174, wherein the first particle group or the second particle group comprises secondary particles each formed from a plurality of primary particles, wherein the secondary particles have a spherical morphology.
